(19) United States
(12) Patent Application Publication
(10) Pub. No.: US 2006/0230427 A1
(43) Pub. Date: Oct. 12, 2006

(54) Method and system of providing user interface

(76) Inventors: Gerard Kunkel, Yardley, PA (US); Steve Silva, Bryn Mawr, PA (US); Ty O. Ahmad-Taylor, New York, NY (US); James Capps, Wheat Ridge, CO (US); Mitchell J. Weinraub, Englewood, CO (US); Gary Traver, Parker, CO (US); Daniel P. Groustra, Littleton, CO (US); Michael Chen, Wallingford, PA (US); Griffin Moore, Morrison, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 11/093,627

(22) Filed: Mar. 30, 2005

(51) Int. Cl. H04N 7/173; H04N 7/16; H04N 7/18

(52) U.S. Cl. 725/133; 725/80; 725/100; 725/141

(57) ABSTRACT

Method and system of providing a user interface. The method and system relating to the user of a media device to support displaying video and the user interface in a video rich fashion. The method and system may provide dynamic operations which provide increased functionality and interactivity, such as to provide a multi-functional user interface and navigation portal which provides aesthetically pleasing and functional mosaics of video, advertisements, textual and graphical displays, and other motion or non-motion based displays.

### BACKGROUND OF THE INVENTION

1. Field of the Invention

The present invention relates to methods and systems of providing a user interface.

2. Background Art

Cable, satellite, and other media providers typically provide a media device to their subscribers. The media device decrypts, encodes, and otherwise manipulates signals to support communications between the providers and customer premises equipment. The media device is typically a standalone device, such as a settop box (STB) or modem, which exchanges signals with any number of pieces of customer premise equipment at the customer location, such as a television, home network, computer, etc. In the future, the media device and/or the functions it performs may become integrated with the customer premises equipment.

The media device may be programmed with applications and other features to facilitate subscriber interaction with the media provider. The applications may be embedded on the media device and/or pushed downstream through file downloads or other applications. The applications may be configured to support any number of activities and interactions with the subscribers and between the media device and other customer premises equipment in communication therewith.

As newer technologies develop and the number of available services increases, the media service providers are presented with opportunities to increase customer service offerings. The newer offerings, however, may require downloading or otherwise providing new applications to the media devices for supporting the operation thereof. For example, one relatively recent development is the use of electronic programming guides (EPGs) and video on demand (VOD) guides to support channel surfing and VOD ordering.

These newer applications, however, are typically standalone applications which have little if any interaction with each other or with other capabilities of the media device. The media device may include any number of other applications or features, such as features for supporting web-based or network based activities, video and audio recording (DVR), and the like. As such, there exists a need to provide an improved user interface which permits navigation utilize between the ever increasing capabilities of the media devices.

Traditional time and channel layout grid-based EPGs and VOD guides are becoming more outdated as providers become more desirous of enhancing appearances and functionality provided in such user interfaces. The use of video can be one avenue to further develop these and other interfaces to meet increasingly higher user satisfaction standards. The processing capabilities of the media devices, especially older media devices which have been in use for longer periods of time, may adversely influence the ability of such devices to support these newer offerings. One solution to this problem is to perform the processing at locations upstream from the media devices.

One particular problem addressed by upstream processing relates to desires to include multiple videos within the user interfaces. The processing associated with simultaneously displaying multiple video feeds on the television screen can be too demanding for some media devices. Some media providers, therefore, process the video feeds at locations upstream from the media device so as to limit processing demands on the media device. The upstream processing, however, is typically provided through fixed infrastructures and processes.

Another problem addressed with such upstream processing relates to the inability of such systems to change data and other information transmitted to the media device. The media device may include applications and other features which operate as a function of data communicated thereto. Applications, such as EPGs and VOD guides, typically receive data once a day or at longer intervals due to the manually intensive processes required to provide new data to the media devices. These upstream processing limitations further limit the ability of media providers to update data used by the media device applications.

As described above, there exist needs to support navigation between multiple applications operating on a media device and to improve upstream processing associated with supporting media device operations.

### SUMMARY OF THE INVENTION

One aspect of the present invention relates to a system of providing a user interface. The system may include a media device configured to receive user interface instructions and to output a user interface as a function thereof. The media device may be further configured to receive a video feed. The system may further include an automation processor configured to provide the user interface instructions. The user interface instructions may include features specific to content of the video feed so as to facilitate displaying user interface features that are specific to content of the video feed.

The automation processor may be configured to periodically update the user interface instructions. A scheduler may be in communication with the automation processor to facilitate automatically updating the user interface instructions. The scheduler may specify intervals or other periods associated with updating the user interface instructions and/or for changing content associated with the video feed.

The system may include a database of secondary information to communicate with the automation processor to facilitate updating the user interface instructions. The database may include secondary information relating to content associated with the video feed which may be used by the automation processor to update the user interface instructions. For example, the secondary information may specify at least a portion of the user interface features to be provided within the user interface.

The system may include an encoder configured to facilitate transporting the video feed and user interface instructions to the media device. The automation processor may synchronize the user interface instructions with the video feed to support transporting the video feed and user interface instructions from the encoder to the media device in a common transport stream. The automation processor may synchronize the user instructions to compensate for processing latencies of the media device.

The video feed may be a composite video feed. The composite video feed may be characterized as a single video feed having at least two individual feeds included therein. The media device may only need to tune to the composite video feed to simultaneously display each video feed included therein. The system may include a video processor for combining the individual video feeds into the composite video feed. The video processor may scale the individual video feeds to fit within the composite video feed. The automation processor may be configured to direct the video processor to control sizing of the individual video feeds within the composite video feed. The scheduler may specify sizing of the individual video feeds within the composite video feed so as to facilitate automatically changing video feed sizing. The automation processor may be configured to direct the video processor to control placement of the individual video feeds within the composite video feed. The scheduler may specify placement of the individual video feeds within the composite video feed so as to facilitate automatically changing video feed positioning.

The system may include a separator located upstream from the video processor for separating audio out from the video feeds such that the video processor only processes video into the composite video feed. The system may include an audio processor configured for processing the audio separated out of the video feeds to compensate for processing delays associated with video processing. The system may include an overlay processor for adding an overlay to at least a portion of any blank portions of the composite video feed. The overlay may become part of the composite video feed such that the media device need only tune to the composite video feed to display each video feed and the overlay included therein. The automation processor may be configured to select the overlay so as to facilitate automatically changing graphics, images, or other features associated therewith. The scheduler may specify selection of the overlay so as to facilitate automatically changing the overlay.

The system may include a local insertion unit configured to replace one of the video feeds from the composite video feed with a local video feed. The media device may be a settop box configured to display the user interface and the video feed on a television. The media device may be a server configured to stream the video feed and the user interface to a unit for playback. The system may include user instructions for displaying pop-up navigation features during playback of the video feed from the server.

One aspect of the present invention relates to a system of providing a video rich user interface. The system may include a number of media providers configured to provide one or more video feeds. The system may include a video processor in communication with the media provider to receive the video feeds. The video processor may be configured to combine the video feeds into a composite video feed. The system may include an automation processor configured for selecting the video feeds included within the composite video feed. The automation processor may be configured to provide user interface instructions. The user interface instructions may be specific to content of the selected video feeds. The user interface instructions may provide instructions operable with a media device to display a user interface so as to facilitate displaying features in the user interface that are specific to content of one or more of the selected video feeds. The system may include a scheduler in communication with the automation processor for instructing the automation processor to automatically update, add, or subtract one of the selected video feeds and/or to automatically update the user interface instructions as a function thereof or independently thereof.

The system may include a database of secondary information in communication with the automation processor to facilitate updating the user interface instructions. The database may include secondary information relating to content associated with the video feeds, wherein the automation processor updates the user interface instructions as a function of the secondary information associated with the content of the video feed. The secondary information may specify one or more navigation features to be provided within the user interface, the navigation features being specific to content of the selected video feeds. The secondary information may specific to the one or more advertisements displayed within the user interface such that the advertisements may be specific to content of the selected video feeds. The secondary information may specify one or more textual or graphical displays to be displayed within the user interface, where the textual or graphical displays may be specific to content of the selected video feeds.

One aspect of the present invention relates to a system of providing a user interface. The system may include a composite video feed for displaying a number of individual video feeds. The system may include a number of user interface instructions configured to facilitate displaying at least two different configurations of a user interface, wherein at least one of the configurations covers at least one of the video feeds shown within the composite video feed and wherein at least one of the configurations covers a different one of the video feeds. The system may include a media device configured to display the composite video feed and the user interface.

The system may include an automation processor configured to select an arrangement of the video feeds within the composite video feed and to determine the different configurations of the user interface as a function thereof. The user interface instructions may specify placement of selectable features within the user interface such that the placement of the selectable features controls which one or more video feeds with the composite video feed are shown. The user interface instructions may define the different user interface configurations according to different themes and the video feeds within the composite video feed may be correlated with the different themes so as to permit selection of the user interfaces by theme and the display of the videos associated with the selected theme.

One aspect of the present invention relates to a method of directing operation of a media device having capabilities for displaying videos and a user interface. The method may include providing at least two video feeds within a composite video feed. The media device may be configured to display the composite video feed and thereby each video feed included therein. The method may include providing user interface instructions. The user interface instructions may be operable with the media device to facilitate displaying the user interface. The user interface instructions may include navigation instructions specific to content of at least one of the video feeds within the composite video so as to facilitate providing navigation features within the user interface that are specific to content of at least one of the video feeds.

The method may include configuring the navigation features to facilitate controlling the media device to display an electronic programming guide having content related to at least one of the video feeds. The method may include configuring the navigation features to facilitate controlling the media device to display a pop-up menu having media device control options for controlling the media device to execute operations related to at least one of the video feeds. The method may include configuring the media device control options to facilitate setting a recording of content associated with the video feed, setting a reminder for tuning to a channel showing content associated with the video feed, tuning to a channel showing content associated with the video feed, adding information associated with the video feed to a favorites file, ordering a product associated with the video feed, purchasing a movie associated with the video feed, or others. The method may include configuring the navigation features to facilitate controlling the media device to display a VOD guide having content specific to at least one of the video feeds. The method may include configuring the navigation features to facilitate controlling the media device to engage an application program interface (API). The method may include configuring the navigation features to facilitate controlling the media device to display a webpage having content related to at least one of the video feeds. The method may include configuring the navigation features to facilitate controlling the media device to tune to a channel associated with one of the video feeds.

The method may include configuring the user interface instructions to include instructions for displaying an advertisement. The method may include automatically updating the user interface instructions to facilitate displaying a different advertisement so as to facilitate barking operations wherein different advertisements are periodically displayed within the user interface. The method may include configuring the user interface instructions to include navigation features for transporting to additional information on products or services associated with the advertisement. The method may include configuring the advertisement to display content related to at least one of the video feeds.

The method may include periodically updating the user interface instructions. The user interface instructions may be automatically provided from an electronic database so as to facilitate updating of the user interface instructions without manual interaction. The method may include automatically changing content associated with at least one of the video feeds and automatically providing the user interface instructions to support the changed content. The method may include automatically adding a video feed to the composite video feed and automatically providing the user interface instructions to support the changed content. The method may include automatically subtracting a video feed from the composite video feed and automatically providing the user interface instructions to support the changed content.

The method may include transporting the composite video feed and user interface instructions within a common transport from a location upstream from the media device. The method may include coordinating the user interface instructions to correspond with user interface capabilities of the media device.

The method may include providing user interface instructions for displaying information within the user interface. The displayed information may be specific to content of at least one of the video feeds and it may change according to user interaction with the user interface.

The method may include associating audio feeds with each of the video feeds and configuring the user interface instructions to facilitate selective playback of the audio feeds while the composite video feed and user interface are displayed.

The method may include removing one of the video feeds from the composite video feed and replacing it with a locally inserted video feed. The user interface instructions may be updated with locally inserted user interface instructions to facilitate providing user interface features associated with the locally inserted video feed.

The method may include receiving at least one of the video feeds from a VOD server, a video broadcasting source, a satellite source, a packet-switching network, or in a linear transport. The user interface instructions may be configured to support navigation to a non-linear transport in response to selection of one or more of the features provided in the user interface.

One aspect of the present invention relates to a method of providing a user interface, the method comprising. The method may include providing a video feed and user interface instructions. The user interface instructions may include features for instructing a media device to display features within a user interface during viewing of the video feed. The method may include associating the displayed features with content specific to the video feed such that the user interface displays features specific to the video feed. The method may include automatically updating the user interface instructions at predefined time periods, wherein the user interface instructions are automatically provided from an electronic database so as to facilitate updating of the user interface instructions without manual interaction.

One aspect of the present invention relates to a method of directing operation of a media device having capabilities for displaying videos and a user interface. The method may include providing at least two video feeds within a composite video feed, the media device being configured to display the composite video feed and thereby each video feed included therein. The method may include providing user interface instructions. The user interface instructions may be operable with the media device to facilitate displaying the user interface. The user interface instructions may include instructions to facilitate displaying at least two different configurations of the user interface, wherein at least one of the configurations covers at least one of the video feeds shown within the composite video feed and wherein at least one of the configurations covers a different one of the video feeds. The method may include selectively controlling which one of the user interface configurations is displayed so as to control which one or more video feeds within the composite video feed are shown.

The method may include configuring the user interface instructions to specify placement of selectable features within the user interface such that the placement of the selectable features controls which one or more video feeds with the composite video feed are shown.

The method may include configuring the user interface instructions to include navigation instructions specific to content of at least one of the video feeds within the composite video feed so as to facilitate displaying user selectable navigation options within the user interface that are specific to content of at least one of the video feeds The method may include receiving user requests or inputs with the media device and selectively controlling which one of the user interface configurations is shown as a function thereof. The method may include receiving user requests at a location upstream from the media device and selectively controlling which one of the user interface configurations is shown as a function thereof.

One aspect of the present invention relates to providing a user interface which allows a user to easily navigate from one interface to another or between other features associated with a media device.

One aspect of the present invention relates to providing a user interface which is specific to video content so as to provide video rich navigation capabilities.

One aspect of the present invention relates to automatically updating, changing, adding, or subtracting video feeds displayed within a user interface and/or to automatically updating user interface instructions used to configure the user interface as a function thereof or independently thereof.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system of providing electronic media to a number of media devices in accordance with one non-limiting aspect of the present invention;

FIG. 2 illustrates a video rich navigation system in accordance with one non-limiting aspect of the present invention;

FIG. 3 illustrates a local insertion unit in accordance with one non-limiting aspect of the present invention;

FIGS. 4-5 illustrate a homepage user interface in accordance with one non-limiting aspect of the present invention;

FIG. 6 illustrates a genre user interface in accordance with one non-limiting aspect of the present invention;

FIG. 7 illustrates a composite video feed in accordance with one non-limiting aspect of the present invention;

FIGS. 8-12 illustrate a number of user interfaces in accordance with one non-limiting aspect of the present invention;

FIG. 13 illustrates a flowchart of a method for providing video rich navigation in accordance with one non-limiting aspect of the present invention;

FIG. 14 illustrates a navigation tree for a homepage user interface 502 in accordance with one non-limiting aspect of the present invention;

FIG. 15 illustrates a navigation tree for a VOD user interface in accordance with one non-limiting aspect of the present invention;

FIG. 16 illustrates a navigation tree for a top stories user interface in accordance with one non-limiting aspect of the present invention;

FIG. 17 graphically illustrates a user interface being updated to include locally inserted content in accordance with one non-limiting aspect of the present invention; and

FIG. 18 illustrates a pair of user interfaces configured to support non-English operations in accordance with one non-limiting aspect of the present invention.

### DETAILED DESCRIPTION OF THE PREFERRED EMBODIMENT(S)

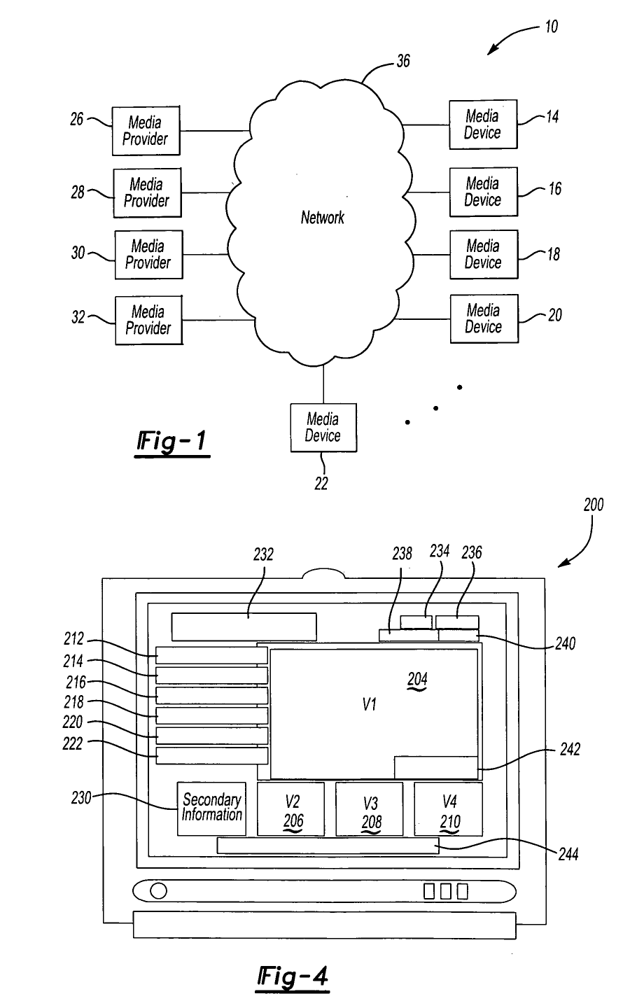

FIG. 1 illustrates a system 10 of providing electronic media to a number of media devices 14-22 in accordance with one non-limiting aspect of the present invention. The system 10 may include a number of media providers 26-32 for providing the electronic media to a network 36 for transport to the media devices 14-22. The system 10 may be configured to provide and transport any number of types of electronic media, including video, audio, data, and the like.

The transportation of such electronic media may be enhanced in accordance with video rich navigation features provided by the present invention. The video rich navigation features may include dynamic operations which provide increased functionality and interactivity. In particular, the video rich navigation features may be used to provide a multi-functional user interface and navigation portal which provides aesthetically pleasing and functional mosaics of video, advertisements, and other motion or non-motion based displays with limited post-production development and cost.

The media providers 26-32 may be associated with any number of media content providers, such as cable or satellite television providers, high-speed data or Internet service providers, audio providers, and other media publishing points. The media providers 26-32 may include any number of features for receiving and outputting media content, including video on demand servers, broadcast television control centers, satellite receivers, video and audio servers, and the like. Of course, the present invention is not intended to be limited to any particular media provider and contemplates the use of these and other media providers.

The network 36 may include any number of configurations and features for transporting electronic media to the media devices 14-22. In particular, the network 36 may be associated with a cable system provider and include features for transporting the electronic media over cable lines and other terrestrial based mediums. Likewise, the network 36 may be associated with other transmission mediums, such as the Internet and terrestrial or extraterrestrial wireless systems, such as satellite systems. Of course, the present invention is not intended to be limited to any particular network or network transmission medium and contemplates the use of these and other networks.

The media devices 14-22 may include any number of devices configured to receive and output the electronic media to the users, including settop boxes (STBs), media terminal adapters (MTAs), outlet digital adapters (ODAs), modems, servers, databases, tuners, televisions, recorders (PVRs, DVRs, etc.), audio output units (stereos), IP based telephones (VoIP phones), personal digital assistants (PDAs), media centers, portable media players, portable media devices, and/or combinations thereof. Of course, the present invention is not intended to be limited to any particular media device and contemplates the use of these and other devices.

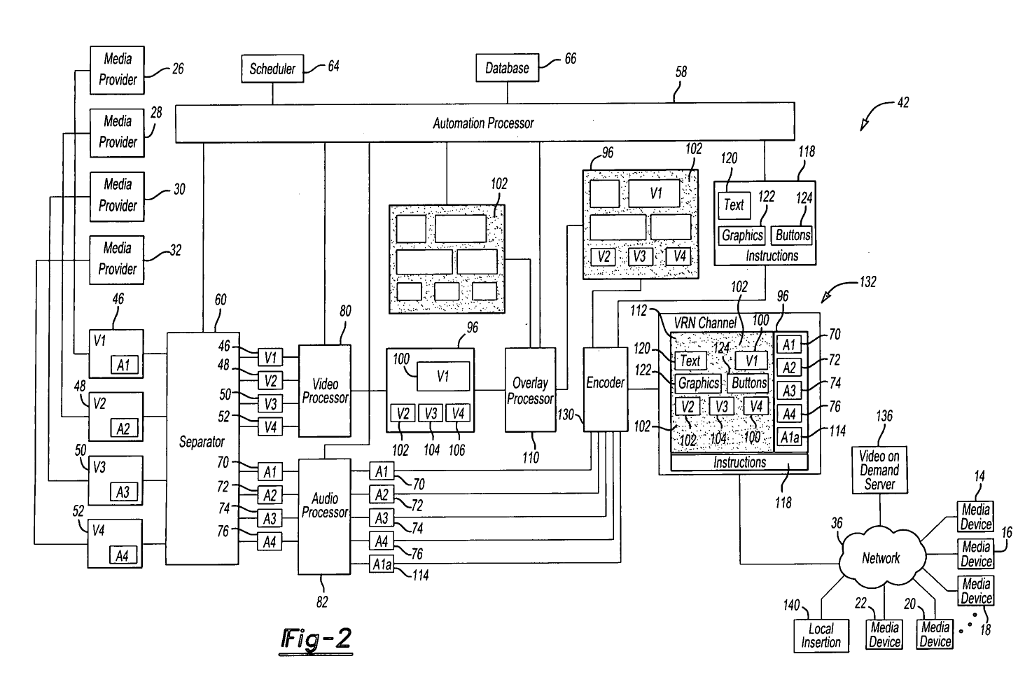

FIG. 2 illustrates a video rich navigation system 42 configured for interfacing between the media providers 26-32 and the network 36 in accordance with one non-limiting aspect of the present invention. In general, the video rich navigation system 42 is suitable for receiving video feeds 46-52 from one or more media providers 26-32, generating user interface instructions for displaying, navigating, and performing other operations related to the video, and transporting the video and instructions to the network for transport to one or more of the media devices 14-22 or other network related items.

The video rich navigation system 42 may be used in any number of environments, including cable systems where regional or local enterprises transmit signals to media devices over cable lines and other mediums, satellite systems where extraterrestrial satellites communicate wireless signals directly to media devices and/or to local enterprises associated therewith, and packet-switch network environments, such as the Internet or other local and wide area networks, where signals may be packetized for addressable communication, such as through Transmission Control Protocol/Internet Protocol (TCP/IP) and the like.

The system may include an automation processor 58 or similar processor to control signal processing and perform other operations associated with transporting the video feeds 46-52 and generating user interface instructions. The processor 58 may include a microprocessor, memory, or other features for executing software applications and other logic based processes associated with controlling, manipulating, and otherwise directing operations.

The automation processor 58 may include features for assessing video feeds available from one or more of the media providers 26-32 and selecting one or more of the available feeds for transportation to a separator 60. This may include any number of operations and the transportation of video from any number of sources, such as from a national or regional video repository, a broadcast or other television provider, a video storage server (video on demand or other streaming servers sourced from the internet), and other media publishing points.

The automation processor 58 may include a traffic and billing scheduler 64 or other scheduling feature to facilitate assessing and selecting the video feeds 46-52. A scheduler 64 may be in communication with a database 66 associated with the automation processor which specifies time based triggers or other triggers that prompt the automation processor to take action. For example, a system operator may generate a time based schedule that specifies one or more video feeds to be included in the user interface over a period of time. The schedule generated by scheduler 64 may be a look-up table or other stored feature which cross-references the desired video feeds 46-52 with video feed identifiers so as to facilitate locating and routing the video feeds associated therewith to the separator 60.

The schedule may be generated by a system operator or other entity associated with servicing the media devices 14-22. It may be generated according to any number of criteria, including user selected preferences, advertising selections, and the like. In addition to associating the video feed identifiers with the available video feeds, the schedule may further cross-reference the video feed identifiers with secondary information, such as program-specific information, program-specific advertisements, and the like.

Optionally, some of the secondary information may be extracted from metadata provided by the media providers 26-32 themselves or other vendors, such as an EPG vendor. In more detail, vendors and media providers may provide a synopsis or other summary of the program, lists of actors and actresses, ratings, running times, and other information associated with the video feeds. This information may be processed by the automation processor or through a separate processor for inclusion with the scheduler and cross-referencing with the video feed identifiers.

As described below in more detail, the secondary information may be packaged with the video feeds 46-52 and displayed in the user interface. The secondary information may be tied to the video feeds such that the information is specific to the content associated with the video feeds 46-52. In this manner, the present invention is able to associate secondary information with one or more of the video feeds and to display such information in the user interface. This allows the present invention to provide enhanced viewing of the video feeds 46-52 and additional opportunities to facilitate the selection thereof.

The scheduler 64 may list media providers as a function the media content which they provide, such as to facilitate locating media content which may be available from one or more media providers. Furthermore, addressing information may be associated with the media providers to indicate relevant addressing protocols and features associated with communicating between the separator 60 and media providers 26-32, including addressing and signaling parameters associated with transmitting signals from the media provider to the separator 60.

In the case of multiple media providers supporting the same video feed, the addressing information may provide addresses for each media provider so as to facilitate the selection thereof, such as to facilitate selecting the media provider having the quickest response or delivery times and/or to facilitate selecting the media providers having lower subscription rates or delivery fees. In some cases, the media provider and addressing information may also be used to assess a number of media providers to determine whether video feeds believed to be available therefrom are actually available, as some providers may have gone off-line or experienced other interruptions in service. This may include communicating with media providers to determine video feed availability and determining scheduling parameters as a function of the available video feeds.

The secondary information may include additional data information associated with the video feeds, such as title, synopsis, actors/actresses, length, and rating information. This information may be inputted manually by a system operator or automatically from information or other metadata provided by the media providers 26-32 or vendors. The title may relate to a title of the program associated with the video feed. The synopsis information may relate to a short summary of the program associated with the video feed and it may be edited as desired by the system operators or others associated with the system. The actors/actresses information may list the actors and actresses related to the video feed and the characters they play. The length information may indicate the length of the video feed and/or the length of the program associated therewith, or in the case of the video feed being a short clip, information related to the length of a feature or program associated with the clip. The rating information may indicate an advisory rating associated with the video feed, such as PG-13, R, etc.

The secondary information may include advertising data. The advertising data may be used to instruct the user interface to display advertisements related to the video feeds, i.e., to provide content specific advertisements and other generic advertisements related to other products, services, and features associated with the media providers or system operator. The advertisements may include logos, texts, graphics, and other advertisement related features. The advertisements may specify selectable buttons and other features that may be selected for ordering the product or service and/or to perform other operations related thereto, such as instructions for instructing the media device to tune to a webpage or other feature associated with the advertisements, like a video on demand movie feed.

The user interface may display multiple advertisements either simultaneously and/or on a rotational basis. Preferably, the advertisement related features may be updated or otherwise changed when the video feeds 46-52 associated therewith change so as to facilitate coordinating the advertisement features with content provided in the video feeds. The advertisement may be tied to pay-per-view or other on-line purchasing capabilities so that user may purchase items associated with the advertisement through the user interface.

The secondary information may also specify navigation features for inclusion within the user interface. The navigation features may be specific to the content of the video feeds 46-52 and/or generic navigation features. The navigation features may be selectable buttons, icons, menus, or other features which may be selected to transport the user to different user interfaces, pages, channels, or other locations. Alternatively, the navigation features could be implemented to automatically transport the user to a different location. Preferably, the navigation features are updated or otherwise changed when the video feeds 46-52 provided to the separator 60 change so as to facilitate coordinating the navigation features with content provided in the video feeds.

As described above, the scheduler 64 or other application associated with the automation processor 58 may cross-reference the desired video feeds 46-52 with video feed identifiers to facilitate locating and routing the video feeds 46-52 to the separator 60. In particular, the automation processor 58 may address requests for video feed deliveries directly to the media providers 26-32 and/or to the separator 60. Of course, the present invention contemplates any number of configurations for transporting the video feeds 46-52 to the separator 60 and otherwise facilitating routing of the video feeds thereto.

The separator 60 may be configured to receive video feeds from the media providers 26-32 and to separate out audio portions 70-76 from the video portions. The separator 60 may be instructed by the automation processor 58 to locate the video feeds 46-52 as a function of the video feed identifiers, such as through addressing operations and the like. In addition, the separator 60 may communicate available video feeds to the automation processor for use in selecting the one or more video feeds.

The separator 60 may separately output the video feeds and audio feeds to respective video and audio processors 80-82. The processors 80-82 may be configured and instructed by the automation processor 58 to manipulate the video and audio for subsequent playback in the user interface. As shown, the video processor 80 receives four video feeds 46-52 and separates each feed into a corresponding number of video feeds 46-52 and audio feeds 70-76. Of course, the present invention is not so limited and contemplates the video processor 80 receiving and separating signals from any number of feeds and from any number of media providers.

As described above, the scheduler 64 may include time based triggers or other triggers associated with selecting and transporting the video to the video processor. In addition, the scheduling information may also specify the duration of such transport, such as whether only brief video clips are to be transported, such as for barking operations, or whether full-length feeds are to be provided, such as to facilitate real-time viewing, broadcasting, or movie watching. Moreover, the scheduling information may include instructions for continuously switching the video feeds 46-52 routed to the separator 60 so as to facilitate real-time viewing of different video feeds 46-52.

The video processor 80 may be configured to combine multiple video feeds into a composite video feed 96. This may comprise any number of operations which result in the composite video feed 96 including videos from one or more of the video feeds 46-52. The multiple video feeds 46-52 may be scaled to fit within the same viewing area associated with a non-scaled video feed. The scaling generally relates to removing pixels or other video segments from the video feeds 46-52 so that the feeds may be reproduced on a smaller scale.

The automation processor 58 may include applications and features for interacting with the video processor 80 and controlling the scaling and positioning of the video feeds 46-52 into the composite video feed 96. For example, the automation processor may transmit signals to the video processor 80 to control placement and other features associated with arranging the separate video feeds 46-52 into the composite video feed 96 as a function of arrangement, scaling (data reduction), compression, resolution, and other video related information specified in the scheduler 64 or other inputs thereto.

The video processor 80 may combine, arrange, or otherwise manipulate the video feeds 46-52 into any number of configurations and patterns to provide picture-in-picture (thumbnail) viewing of the videos. For example, the composite video feed 96 may include a primary video portion 100 and one or more secondary video portions 102-106 wherein the secondary video portions 102-106 may be of a smaller size and lower resolution to save bandwidth.

The automation processor 58 may be configured to include a number of templates or layouts for use in facilitating placement of the multiple video feeds within the composite video feed. The scheduler 64 may specify which one of the video layout templates is to be used so as to facilitate the selection thereof. The video feeds 46-52 may then be combined in the composite video feed 96 so that the media devices 14-22 are only required to tune to the composite video feed 96 in order to view each of the video feeds 46-52, as opposed to applications which require multiple tuners to independently tune to each of the video feeds 46-52. This may be advantageous for media devices having limited memories and processing capabilities as it eliminates the need for such media devices to process and arrange the videos prior to outputting them to a television or other device on which the user interface may be displayed.

As noted above, the present invention contemplates incorporating more than one video feed 46-52 within the composite video feed 96, however, the present invention is not so limited. Rather, the present invention contemplates applications where only one video feed may be provided to the video processor 80 such that the composite video feed 96 includes only videos from one video feed, which may be advantageous for VOD applications where it is desirable to store secondary information and data with the stored video, such as to facilitate playback of the stored video with pop-up features or other navigatable items. Optionally, the resolution, and in some cases scaling, of the single video feed may be controlled through the video processor.

The composite video feed 96 outputted from the video processor 80 is preferably in a format suitable for viewing with the media devices 14-22, such as on a television screen or other visible medium. It may include dead-spots or non-video portions between the video portions 100-106 which are devoid of videos or other features such that if viewed on the television, the dead-spots would appear as blank sections on the screen. The size and positioning of such dead-spots may be determined as a function of the video template used by the automation processor 58 for positioning the multiple video feeds 46-52 into the composite video feed 96.

An overlay processor 110 may be included to add a video overlay 112 onto the composite video feed so as to fill the blank portions with a background of graphics, videos, colors, or other visual features. For example, the automation processor 58 may retrieve footprints, backgrounds, and other information from the database for inclusion within the composite video feed 96 according to instructions provided in the scheduler.

The insertion of graphics or other features with the overlay processor 110 may be especially advantageous in combination with media devices having limited processing capabilities, as the background becomes part of the composite video feed 96 such that the media device is only required to tune to the composite video feed 96 to display the background and is not required to perform additional on-site data processing to display the background.

The audio processor 82 may operate in parallel with the video processing associated with the video processor 80 and overlay processor 110. The audio processor 82 may perform any number of operations on the audio feeds 70-76. If the audio feeds 70-76 are monaural feeds, for example, the audio processor 82 may be configured to add a second audio feed 114 to one or more of the monaural feeds so as to provide two-channel monaural feeds that simulate or approximate stereo sound. As shown, the second audio feed 114 is associated with the first audio feed to provide enhanced sound. The audio processor 82 may be configured to delay transport of the audio feeds 70-76 in order to compensate for time spent processing the video feeds. Optionally, the automation processor 58 may communicate with the audio processor 82 to control, monitor, or otherwise influence the operation thereof.

In addition to the foregoing, the automation processor 58 may be configured to generate user interface instructions 118. The user interface instructions 118 are preferably associated with the media devices 14-22 in that they may be used for instructing the media devices 14-22 to display a user interface (see FIGS. 4, 5, and 8-12). The user interface instructions 118 may include commands, logic, or other features associated with displaying or otherwise outputting a user interface. If the media devices 14-22 are settop boxes (STBs), for example, the instructions may be associated with an instruction vocabulary associated with the STBs or the manufacturer thereof. The STBs, or other media device is capable of receiving the composite video feed, may be configured for separating out and interpreting the user interface instructions.

The instructions 118 generated may dictate the creation of the user interface and leverage off of existing software applications and architectures associated with the media devices 14-22. For example, the media devices 14-22 may be pre-loaded with applications such that the user interface instructions 118 may be configured to support a user interface which interacts or otherwise provides navigation features to integrate operations with such applications. For example, the media devices 14-22 may include an electronic programming guide application, video on demand application, webpage viewing applications and the like. The user interface instructions 118 may be correlated with these applications to display selectable features which allow the user to transport directly to such applications without having to separately launch the operation thereof.

The instructions 118 provided by the automation processor 58 are preferably provided according to the capabilities of the media devices 14-22 so that the automation processor 58 need only specify which operations are to be performed, i.e., without requiring detailed instructions on how to execute the operations, as the execution thereof is preferably dictated by the software, logic, and other applications already existing on the media device. The ability of the automation processor 58 to tailor the instructions to the media devices 14-22 is advantageous because it allows the present invention to operate with any number of media deices 14-22 and any number of media device manufacturers and protocols. This allows the present invention to limit the amount of information and data required for transport to the media device in order to display the user interface.

The user interface may include a number of selectable features, buttons, menus, or other options which are displayed in a graphical user interface, program guide, or other interactive features associated with the media device. The user interface features may also be associated with the above-described secondary information so as to provide a user interface tailored to the one or more of the video feeds. Preferably, at least a portion of the selectable features provide navigation options to the user, such as to support engaging other applications and features already existing on the media device, to support issue commands and signals to other devices in communication therewith, such as DVRs or other hard drive storage units, and/or to facilitate transporting the user to different locations, pages, interfaces.

The instructions 118 may specify information for assisting the media device in placing text, graphics, and buttons according to X-Y coordinates in a grid-based coordinate system associated with the media devices 14-22. The instructions 118 may further provide information as to what operations are to be performed with the selection thereof. The media devices 14-22 may receive selections according to the X-Y coordinates associated therewith, consult the instructions 118 provided by the automation processor to determine what operations to perform in response thereto, and then consult its operation programming to determine how to execute the desired operations, such as to determine how to tune to a channel specified with the selected feature, how to tune to another user interface associated with the selected feature, to set a reminder for viewing another channel, to set up a DVR recording, purchasing a movie on demand, ordering a product, and the like.

The automation processor 58 may generate specific user interface instructions 118 as a function of the above-mentioned secondary information such that the user interface instructions 118 are associated with one or more of the video feeds 46-52. Particularly, the automation processor 58 may cross-reference the secondary information associated with one or more of the video feeds 46-52 based on the video feed identifiers associated therewith. Once the desired secondary information is determined, the automation processor 58 may determine appropriate instructions for instructing the media device to display text 120, graphics 122, buttons 124, and other features.

As described above, the present invention contemplates tying or otherwise coordinating the secondary information with the video feeds 46-52 such that the user interface instructions 118 are determined as a function of the secondary information. This may require generation of new instructions sets and the like each time content associated with one or more of the video feeds 46-52 change so as to facilitate tying the secondary information with content of the new video feeds. In particular, the navigation features specified within the secondary information may need to be updated or changed so as to support transporting the user to different user interfaces, pages, and other locations associated with content of the new video feeds. Likewise, for longer video feeds or full-run applications, the instructions may change even if the content of video feeds remain the same so that additional information may be displayed, such as new commercials and other advertisements.

An encoder 130 may be included to manipulate the composite video feed 96, audio feeds 70-76, 114, and user interface instructions 118 for transport over the network 36 to the media devices 14-22. The encoder 130 may be configured to output a video rich navigation (VRN) feed 132 which includes the composite video feed 96, audio feeds 70-76, 114, and other data associated with instructing the media device to display the user interface and perform other operations related thereto. Thus, in one MPEG transport stream, multiple video streams (or thumbnails) of live video can be transported along with their accompanying user interface instructions 118. The VRN feed 132 is preferably carried in a single transport so that the media devices 14-22 are not required to tune to multiple transports in order to view the composite video feed and receive the user interface instructions. The encoder 130 may control compression efficiencies, density/quality, and other parameters associated with the video and user interface, such as to adjust quality and resolution at different areas of the screen.

The VRN feed 132, for example, may be a channel associated with a channel broadcast by a cable or satellite provider. The VRN feed 132 may occupy a designated frequency band within a transmission medium used to transport signals through the network 36 to the media devices 14-22. In this manner, the composite feed 96, audio feeds 70-76, 114, and associated instructions 118 are communicated together in a common transport. The automation processor 58 may facilitate synchronization of the signals so that the appropriate information is transported to the media devices 14-22. The synchronization may include delivering the user interface instructions 118 in advance of the composite video and audio feeds to compensate for processing delays and other latencies inherent to operations of the media devices 14-22. This may be advantageous to insure the appropriate user interface features and options are displayed when the video and audio feeds associated therewith arrive at the media device.

The present invention contemplates applications where the user interface instructions 118 may need to be only periodically included within the VRN feed 132. In particular, some applications may desire changing only the video feeds 46-52 and not the user interface instructions 118, i.e., if the video feed is associated with common content and/or if the user interface is generic, such that the user interface instructions 118 may be included to initialize set-up operation of the user interface and not thereafter, unless the features provided therein need to be updated or changed.

The present invention contemplates transporting the user interface instructions and other date in an out-of-band (OOB) form. This would allow the devices down stream to ingest and then act upon the data stream after the video component has been generated. By using an out of band (separate frequency) the transport could be created with content that originates elsewhere. This may support applications where user instructions and other data is transported separately from the video, and in some cases, processed together with the video for the first time at the media device, as opposed to a location upstream therefrom.

Likewise, the present invention contemplates other processes and features for deregulated transportation and compiling of the video, audio, and user interface instructions, such as to facilitate downstream assembly. In particular, the video, audio, and user instructions may each be separately transported the media devices 12-22 such that the media devices 14-22 create composite image feeds and generate the user interface instructions for the secondary data. Of course, the media devices 12-22 may need to include enhanced processing capabilities to support such activities.

The present invention contemplates a dynamic environment where the automation processor 58 may continuously update and change the video feeds 46-52 and secondary information such that the information transmitted over the VRN feed 132 is constantly changing. The present invention contemplates an enhanced barking operation wherein the user interface may be constantly updated to show different video feeds 46-52 and secondary information. Such operation may require the automation processor 58 to continuously synchronize the instructions with new video and audio feeds to insure the appropriate instructions are provided with the appropriate video and audio feeds.

The present invention contemplates a rapidly changing environment where one or both of the video feeds 46-52 and user interface instructions 118 are changing at relatively short intervals, such as from every six hours to almost every second or less (i.e., content of the video may change and/or more or less video feeds may be added or subtracted from the composite video feed). The automation processor 58 may be configured to support such variability as it may be configured to automatically collect secondary information associated with the changing video feeds 46-52 from the database and to automatically provide the user interface instructions 118 associated therewith. This allows to the present invention to change content on the fly and without a high level of user interaction.

Likewise, the automation processor 58 may be configured to support multiple VRN feeds 132 so as to simultaneously support multiple user interface pages. In this manner, each user interface page may provide different combinations of video feeds, audio feeds, and instructions to the media devices. Operators of the media devices 14-22 may then select which one of the VRN feeds 132 to tune to and thereby control which user interface is displayed.

The VRN feeds 132 may be transported to media devices having extended storage capabilities, such as to a video on demand (VOD) server 136, a digital video recorder (DVR), or other hard drive or permanent storage device. In this manner, entire videos may be associated with user interface instructions and stored on the server 136 for streaming to one or more media devices 14-22, such as to users who purchase movies on demand from another user interface provided by another VRN feed.

The stored movies may be streamed from a VRN feed originating at the VOD server 136 or on any other hard drive such that the streaming signals include user interfaces instructions associated with the secondary information. The user interface instructions 118 may be used to provide any number of options for facilitating playback of the video, such as fast forward, rewind, and the like, and other operations, such as pop-ups and selectable menus which overlay the movie and/or appear periodically during playback.

This functionality may be advantageous in facilitating advertising and tunneling (telescoping) operations where users may discover additional details on products and other offers associated with the stored video and also have the capability of jumping from one stored asset to another, such a by tunneling through VOD servers and other hard drives for more information, and to bookmark this content to view later. Moreover, the single content of video on demand or other stored applications may permit intermittent distribution of the user interface instructions so as to save bandwidth and shorten transmission times.

Although shown and described as separate components, two or more of the features shown in FIG. 2 may be combined into a single unit. For example, the separator 60, video processor 80, audio processor 82, overlay processor 110, automation processor 58, and/or encoder 130.

The present invention contemplates the VRN feeds 132 being communicated over any number of mediums and to any number of geographical areas. In particular, the present invention contemplates transmitting the VRN feeds 132 from a regional enterprise, such as a national content repository, to one or more local enterprises, such as regional headends, such that the local enterprises are responsible for transporting the VRN feeds 132 to the media devices 14-22.

Optionally, the local enterprise may include capabilities similar to those described above for adding locally based secondary information and video feeds to those carried in the VRN feeds 132. For example, a local insertion unit 140 may remove one or more of the video and audio feeds and the user interface instructions associated therewith. This media may then be replaced with one or more local video feeds and user interface instructions associated therewith. The VRN feed having locally inserted features may then be transported over the network, which may be a regional network, in a similar manner as the VRN feed 132 emitted from the encoder 130. The local insertion unit 140 may also be configured to overlay or otherwise insert the local content without having to remove or delete the old content.

FIG. 3 illustrates the local insertion unit 140 in accordance with one non-limiting aspect of the present invention. The unit 140 may include a receiver 146, audio extractor 148, audio shuffler 150, audio delay 152, router 154, digital video editor (DVE) 156, keyer 158, encoder 160, local data injector 162, local server 164, user workstation 166, and GPS timecoder 168. Of course, the present invention contemplates any number of configurations and features for the local insertion unit 140 and is not intended to be limited to the foregoing.

The local insertion unit 140 may be configured to replace or overlay one or more of the video feeds 46-52 and the audio feeds 70-76 with locally generated video and audio feeds, and associated user interface instructions. A local programming source 170 may be configured to provide a local video feed 176 having video and audio portions. The router 154 may be configured to separate the video feed 176 into separate video and audio portions 176-178.

The receiver 146 may be configured to tune to the VRN feed 132 outputted by the encoder 130 and communicated thereto over the network 36. The receiver 146 may be configured to separate the composite and audio feeds carried in the VRN feed. The audio feeds may be delivered to the audio extractor unit 148 and the video feed and user instructions may be delivered to the keyer 158.

The audio extractor unit 148 may be configured to separate out the audio feeds carried in the VRN feed 132. The individual audio feeds from the VRN channel 132 and the local audio feed 178 may be transported to the audio shuffler 150. The audio shuffler 150 may be configured to remove or overwrite one of the VRN audio feeds and replace it with a local audio feed 178 according to instructions provided by the local server 164, which may include an automation processor or other feature for controlling operations. The audio feeds may then be processed with the audio delay unit 152 to compensate for processing delays associated with inserting the local video feed.

The local video feed 176 outputted from the router 154 may be communicated to the DVE 156 for manipulation prior to insertion within the VRN feed. The manipulation of the local video feed 176 may include scaling the local video feed to correspond with one of the video feeds carried in the composite feed 96. For example, if the local video feed is to replace one of the secondary video feeds 102-106, then the DVE 156 may be configured to scale the local video feed to fit within the portion of the composite feed 96 assigned thereto.

The local video feed 176 may then be transported to the keyer 158 for inclusion within the VRN feed 132. The keyer 158 may be configured to strip out or otherwise remove or overlay one of the video feeds 46-52 from the composite feed 96 and replace it with the local video feed 176. This may require synchronization with the VRN feed 132 so as to facilitate real-time operations. The local server 164 may be configured to support such synchronization.

The local server 164 may coordinate the insertion of local media by communicating with the automation processor 58 or via satellite 168 and/or in response to instructions inputted thereto by way of the user workstation 166. The automation processor 58 may provide time-coded information to the local server 164 regarding which VRN feeds are scheduled to appear over time. The local server 164 may then leverage off of this information to control inserting the local video feed 176 as a function thereof.

The local server 164 may be configured to provide local user interface instructions 180. The local user interface instructions 180 may be correlated with the local video feed 176 so as to support user interface features associated therewith. For example, local user interface instructions 180 may be provided to display local advertisements or other features associate with the local video feed 176.

The encoder 160 may be configured to receive the VRN feed 132 from the keyer 158, the audio feeds from the audio delay 152, and the local user interface instructions 180 from the local data injector 162. The encoder 160 may be configured to combine the signals for transport in a common transport stream. The encoder 160 may include features for overwriting or otherwise replacing the VRN feed user interface instructions with the locally generated user interface instructions.

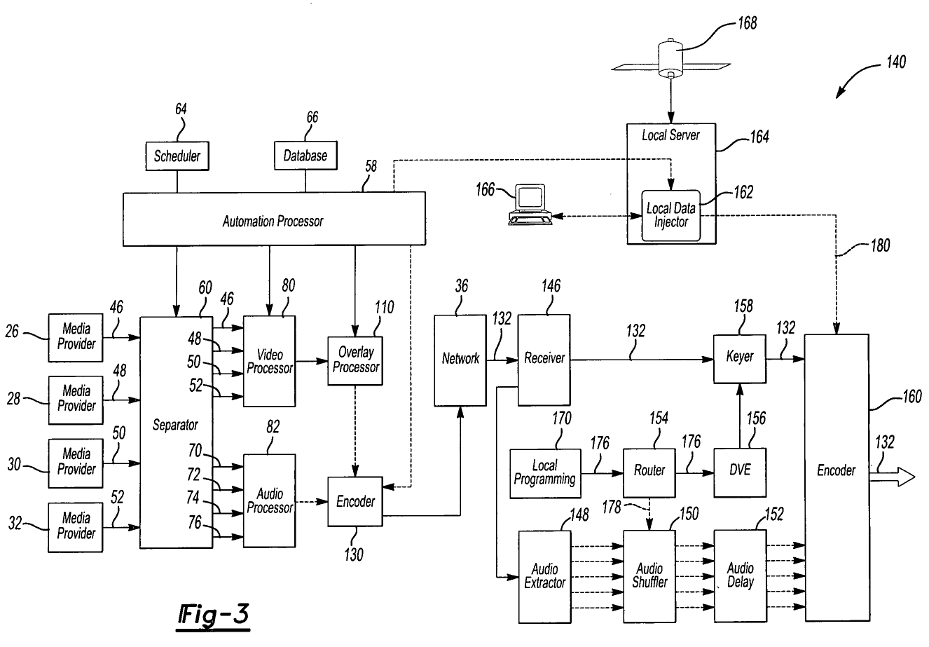

FIGS. 4-5 illustrate a homepage user interface 200 in accordance with one non-limiting aspect of the present invention. FIG. 4 relates to a generic configuration for the homepage user interface 200 and FIG. 5 relates to a populated version of the homepage user interface 200.

The homepage user interface 200 illustrates one exemplary configuration for the above-described user interface that may be displayed on a television through a STB or on any display through another media device 14-22. The homepage user interface 200 may be displayed on the media devices 14-22 in response to any number of inputs or operations, such as with selection of a remote control button, selection of an icon or other feature within an EPG, and the like.

The homepage 200 may be configured to include any number of features, including a primary video window 204, a number of secondary video windows or openings 206-210, a number of selectable menus 212-222, and a number of textual and graphical displays 230-244. The primary video windows 204-210 are openings or other transparent portions within the user interface 200 through which the video feeds 46-52 may be viewed.

According to one non-limiting aspect of the present invention, the primary video window 204 can include a video feed for which content is changing on a relatively frequent basis (e.g., every 15 seconds to 2 minutes), while the secondary video portions 206-210 may display live video feeds from various broadcast channels. Of course, the homepage user interface 200 is not limited to this configuration, and other features and associated video feeds are fully contemplated by the present invention.

In operation, the media devices 14-22 tune to the VRN feed 132 associated with the homepage user interface 200 and outputs the composite video feed to a television or other device. This “homepage” channel may require no more than the bandwidth than that typically assigned to a number of television channels of a regular digital channels (e.g., 6 MHz). The audio associated with the displayed video may be selectably controlled for playback by the user by positioning a cursor or other highlighter over the window associated therewith and inputting an audio playback command to a remote control or other input device, or by simply highlighting the window with a cursor. The audio associated with the primary video window 204 may be in stereo and the audio with the secondary video portions may be monaural to save bandwidth, but alternate configurations are also fully contemplated. The user interface allows multiple videos to be played with the user selecting which one of the videos is heard. Additional functionality may also be provided to allow the user to select a language associated with the displayed information and audio sounds, such as Spanish.

The user interface instructions 118 may be configured to associate navigation features with each of the video portions 204-210, menus 212-222, or display portions 230-244. These features may then be selected, rolled-over, or highlighted to perform operations related thereto. For example, the videos 206-210 may be selected to tune the media device to a channel associated with full screen viewing of the selected video and/or the videos may be selected or rolled-over to cause the media device to display other guides, pages, interfaces, menus, or list of options specific to the content associated with the selected video feed.

The navigation features may be configured to support transporting the user to an electronic programming guide interface which displays guide information specific to content showing in the selected video feed 206-210. For example, if the selected video feed 206-210 relates to football, it may be selected to display an electronic programming guide interface populated with channels associated with various football games. The guide may then be used to select a desired channel for tuning.

Additional uses for the user interface 200 could include, for example, multi-camera applications such as displaying a video or sporting event in the primary video portion 204 and displaying video feeds from different cameras of the same video or sporting event in the secondary video portions 206-210. In another example, a traffic user interface could be provided wherein a traffic channel is displayed in the primary video portion and the video feeds from various traffic cameras at different locations are displayed in the secondary video portions.

The present invention contemplates the navigation features being associated with any number of other interfaces, guides, and applications associated with the media devices 14-22. For example, the navigation features may be associated with an on demand guide such that the video feeds may be selected to display an on demand guide showing movies specific to content associated with the selected video feed. Other options, such as pop-up menus and the like may be displayed with the selection or roll-over of the video windows 24-210 so as to display further navigation features related thereto. Still further, navigation features could include storing a program on a DVR, sending video within a home network, sending video/audio to a car receiver, and others.

The homepage user interface 200 may include a number of selectable menu options for instructing the media device to perform any number of other operations. The menus 212-222, as shown, includes a “TV Guide” button for tuning to an electronic programming guide or other feature which may provide another user interface for reviewing programs shown on other channels, a “Last Channel” button for tuning to the last channel viewed before tuning to the VRN feed associated with the homepage user interface, a “Movies” button for tuning to a different VRN feed having a movies-themed user interface or for displaying a guide related thereto, a “Sports” button for tuning to a different VRN feed having a sports-based user interface or for displaying a guide related thereto, a “News” button for tuning to a different VRN feed having a news-based user interface or for displaying a guide related thereto, and a “Help” button for instructing the media device to display a help menu. Of course, other selectable menu options are also fully contemplated.

Optionally, the video feed windows 204-210 may be highlighted to display secondary information specific to the content associated therewith within one or more of the secondary display windows 232-244. For example, textual or graphical information may be provided for displaying the secondary information as a function of the highlighted video feed, such as to indicate a title, running length, rating, and fees associated with ordering the program on demand.

Advertisements and other information may be displayed in the display window 230. The advertisements may be specific to content associated with one of the video feeds and/or generic advertisements associated with other services provided by the system operator. The displayed advertisement may also change depending on which one of the video windows 204-210 is highlighted so as to provide advertisements specific to the content associated therewith. The advertisement display window 230 may also be associated with navigation features for transporting the user to interfaces, menus, and other applications associated with the advertisement.

The user interface instructions generated by the automation processor may instruct the user interface 200 to provide any number of features and to perform any number of other operations in response to the selection thereof. For example, the instructions may include displaying weather conditions for a geographical area in a weather portion, secondary information associated with one or more of the secondary video windows in a secondary display window, which may optionally change depending on which one of the secondary windows is highlighted, an advertising banner, and a time display, among others.

The present invention contemplates any number of configurations of the homepage user interface 200 and is not intended to be limited to the foregoing. In particular, the present invention contemplates including more or less of the video viewing windows and selecting the content displayed in the user interface according to any number of scheduling and production criteria, such as based on user specific homepages wherein the content associated therewith is specific to one or more users individually associated with the media devices displaying the homepage user interface.

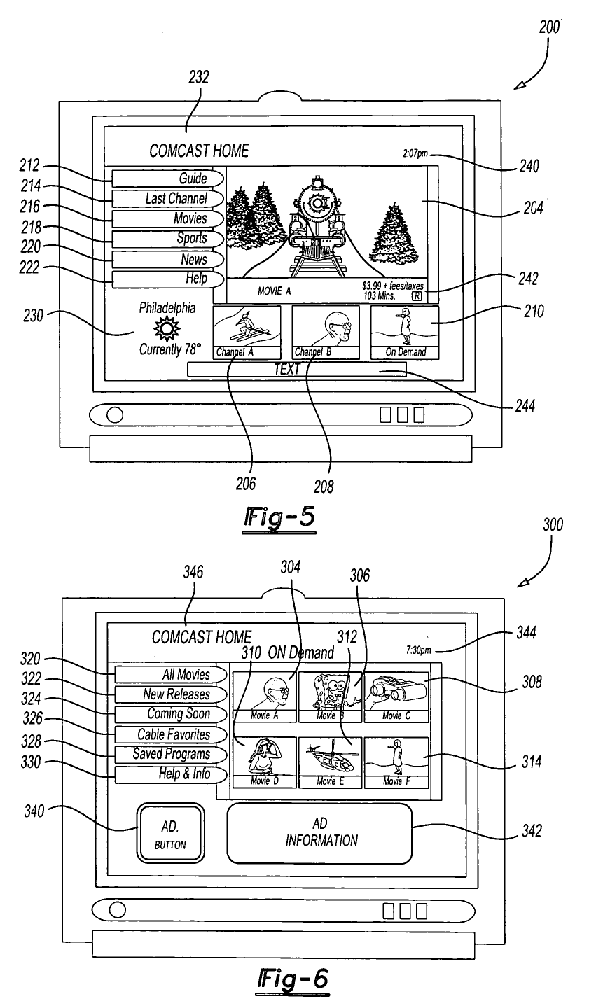

FIG. 6 illustrates a genre user interface 300 in accordance with one non-limiting aspect of the present invention. The genre user interface 300 may be provided through a VRN feed associated with a different frequency band than the homepage user interface 200, such as to facilitate its display in response to user inputs to the homepage user interface and/or as a standalone user interface which may be selected by the user from an electronic programming guide or other feature, like a remote control.

The genre user interface 300 may include any number of video display windows 304-314 associated with any number of video feeds. In the example shown, the genre user interface 300 is configured to facilitate displaying information and features related to on demand content which may be ordered through the media devices 14-22 for on demand viewing. This exemplary configuration includes six video display windows 304-314 for showing video feeds associated with six different programs or movies available on demand. Highlighting any of these windows 304-314 can provide navigation to the full-screen video, a menu for ordering the video, or for performing other functions related thereto.

Like the homepage user interface 200, the genre user interface 300 may include a number of selectable menu features 320-338 and secondary information display windows 340-346. For example, the menu features 320-330 may include a “All Movies” button for displaying a listing of all movies available on demand, a “New Release” button for tuning to another VRN feed associated with new releases or for displaying a guide related thereto, a “Coming Soon” button for tuning to another VRN feed associate with unreleased movies or programs, which may include advertisements and the like, a “Cable Favorites” button for tuning to another VRN feed associate with pre-selected movie favorites, a “Saved Programs” button for accessing personally recorded programs associated with the media device, either locally on a personal recorder such as a DVR or remotely on a server or other feature, and a “Help & Info” button for displaying a help menu and information display.

Secondary information, such as that associated with an advertisement, may be displayed in one or more secondary information displays 340-346. As shown, one of the displays illustrates an advertisement button and another of the displays indicates information associated with the advertisement. The advertisement button may be selected to order the advertised product and the information shown in the display window may scroll through different features of the advertised product.

Optionally, the advertisement button may provide one-click purchasing or similar options for subscribing to or otherwise purchasing the product, subscription, or item associated therewith. The purchasing of such features may be integrated into pay-per-view features or capabilities so that the user's account is automatically charged and the product shipped. It is understood that any features described above with respect to the homepage user interface may be applicable for the genre user interface. Furthermore, it is understood that the user interfaces according to the present invention can have any number and placement of video display windows and display any type and content of video within those video windows.

The system and method of the present invention advantageously allow for more seamless integration between traditional linear programming and VOD programming. Within the user interfaces previously described, the user can jump easily between VOD and linear content. While the previous user interfaces have been described as broadcast channels, it is also possible to provide VOD-based user interfaces which can be created and delivered on demand, thus not requiring a separate broadcast channel and in turn managing local system bandwidth. As with the other user interfaces described, these VOD-based user interfaces can be accessed through one of many access points (e.g., electronic program guide, menus, favorites, another user interface, direct channel input, content search, etc.). Accessing the VOD-based interface will initiate a VOD session that will appear as an interactive, video-rich portal, allowing easy navigation between linear and VOD content. Still further, all of the user interfaces described could also allow for navigation to DVR assets.

FIG. 7 illustrates a composite video feed 350 in accordance with one non-limiting aspect of the present invention. The composite video feed 350 includes a 4×3 matrix of video feeds 360-382 from a number of different genres. As shown, the composite feed 350 includes three sports feeds, one on demand feed, two news feeds, one cable favorites feed, two broadcast feeds, and three movie feeds. The present invention is not intended to be limited to this exemplary configurations and contemplates the inclusion of more or less video feeds and more or less genres.

As described above, each feed 360-382 may provide real-time viewing of content associated therewith. The content may be full-length showings or clips from any number of programs associated therewith. The content may change at intervals to display different videos for the given genres and/or the genres themselves may change at different intervals. The genres and videos may be selected by system operators and/or the subscribers themselves may select them, such as through inputs communicated to the automation processor and/or according to user profile information stored on the database.

Like the composite video feed 96 shown in FIG. 2, the number of video feeds included within the composite video feed 350 of FIG. 7 may change periodically or at regular intervals. The video feeds may be automatically added or subtracted according to instructions provided by the automation processor 58, such as to provide the composite video feed 350 with a 4×4 matrix of feeds instead of the illustrated 4×3 matrix.

The videos included within the composite video feed 350 may be pre-programmed or user specified. The automation processor may be pre-programmed to select the video feeds from any number of media providers and/or the automation processor may be configured to receive user specified video requests. The desired videos may be combined into the composite video feed 350 at a location upstream from the media devices, as described above in FIG. 2, and/or combined at the media device.

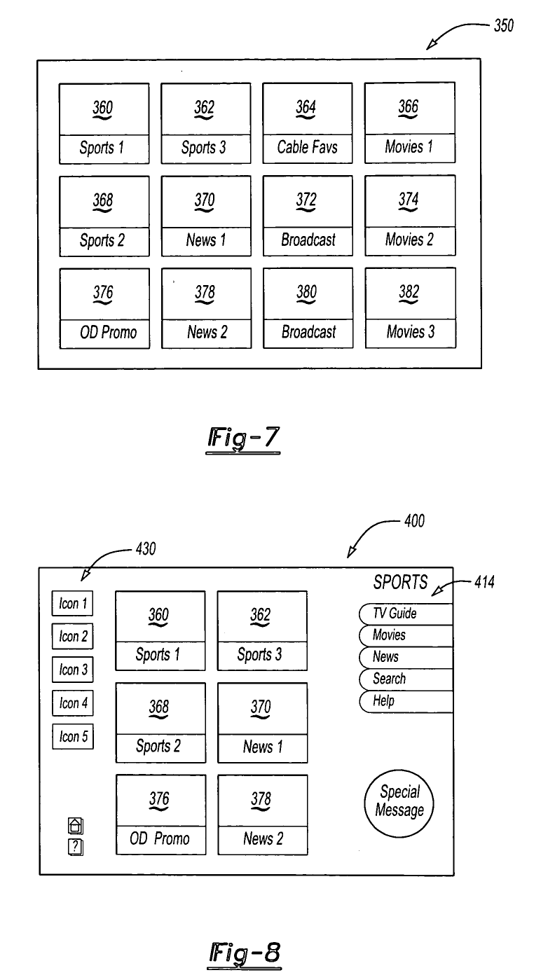

FIGS. 8-12 illustrate a number of user interfaces 400-408 which may be provided in combination with the composite video feed 350 shown in FIG. 7. The various user interfaces 400-408 opaque or otherwise cover one or more of the individual video feeds 360-382. The user may selectively control which user interface 400-408 is displayed, and thereby, control which one or more videos are shown.

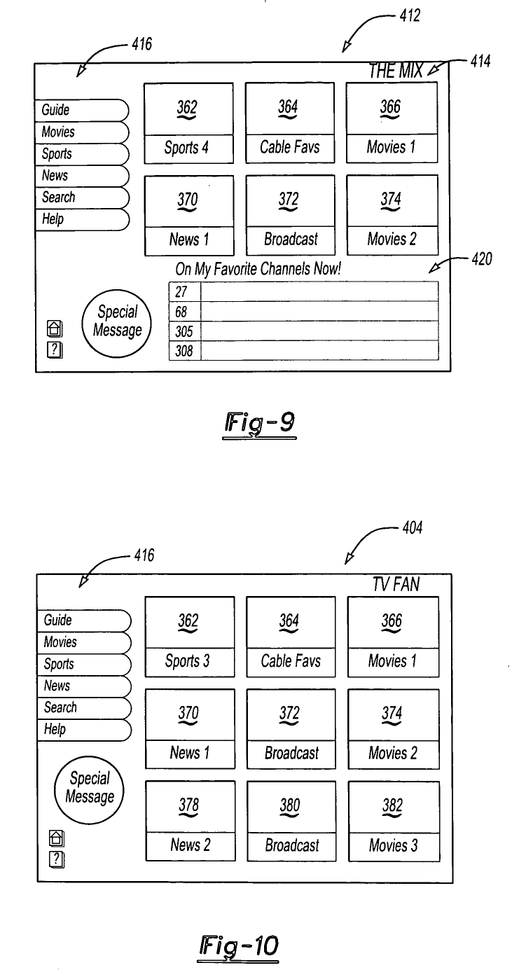

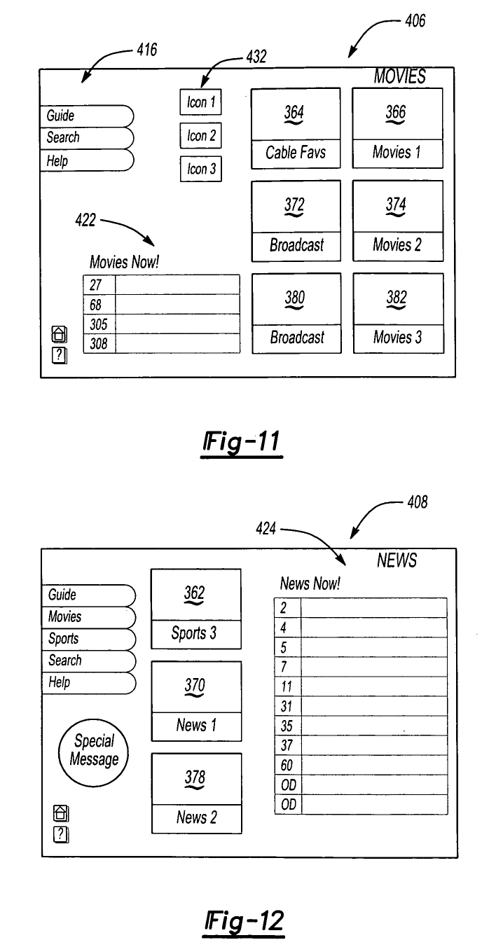

The user interfaces 400-408 may relate to different themes, such as sports (FIG. 8), a mix of genres (FIG. 9), TV only (FIG. 10), movies (FIG. 11), and news (FIG. 12). The user may selectably personalize the features and videos provided in the various user interfaces 400-408. A separate user interface (not show) or other tool may be provided to the user for this purpose.

Multiple sets of user interface instructions may be delivered with the composite video feed 350 to provide navigation features and other user interface options as a function of the content associated with the various video feeds 360-382. The selected user interface 400-408 may then locate the corresponding user interface instructions. The instructions are preferably coordinated with each of the user interfaces and the themes associated therewith. This allows the user to simply select the desired user interface, instead of having to select each of the features displayed in the user interfaces 400-408. However, the present invention fully contemplates the ability of the user to specify each of the features displayed within the user interface and to provide the necessary user interface instructions to support such functionality.

The user interface instructions associated with each user interface 400-408 may include instructions for controlling the placement and arrangement of features provided therein. The location of text or graphical display windows, buttons, menus, and video viewing windows may be specified by the user interface instructions. The user interface instructions may specify the placement of such features within the user interface so as to control which one or more of the video images carried within the composite video feed 350 are shown.

Each of the user interfaces may include different configurations for selectively covering or otherwise opaqueing one or more of the video feeds 350 with features specified by the user interface instructions. For example, a navigation menu 414 shown in FIG. 8 may be located at a right-hand side of the user interface 400 and a similar navigation menu 416 shown in FIG. 9 may be located at a left-hand side of the user interface 402. The different positioning of the navigation menus 414-416 causes different video feeds to be covered by the user interfaces 400-402.

The placement of other features may be selectively controlled to control which one or more video feeds are covered by the user interfaces 400-408. For example, channel navigation menus 420-424 may be provided in different locations of the interfaces (see FIGS. 9 and 12) to control which one or more video feeds 360-382 are covered. The channel navigation menus 420-424 may also be specific to the theme of the user interface and configured to list channels showing content associated with one of the video feeds and/or the theme of the user interface. The channels may be selected to tune the media device to the specified channel and/or to transport the user to other locations associated therewith.

Each genre interface may be associated with a number of predefined options. For example, the sports genre interface may include a number of selectable icons 430 related to various sports genres, like baseball, basketball, football, etc. The user may select one of these navigation features 430 to be transported to guides, portals, interfaces, pages, VOD, or other features associated with the selected icon. The movies interface may include similar icons 432 related to movies, movie categories, artists, and the like. the user may select one of these navigation features to be transported to guides, portals, interfaces, pages, VOD, or other features associated with the selected icon.

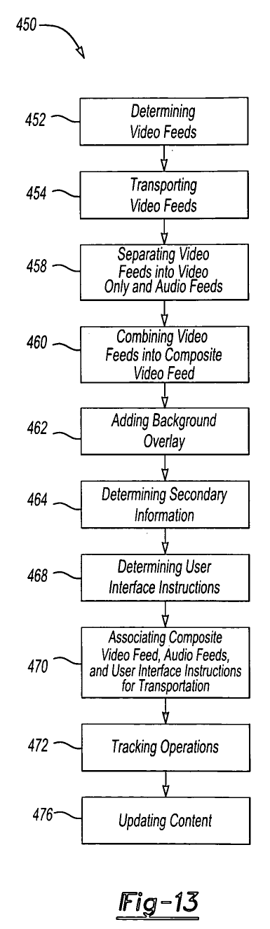

FIG. 13 illustrates a flowchart 450 of a method for providing video rich navigation in accordance with one non-limiting aspect of the present invention. The method may be used in conjunction with the system described in FIG. 2 or other systems having suitable configurations for transporting video feeds and user interface instructions.

Block 452 relates to determining one or more video feeds for inclusion within the user interface. This determination may be based on video feed identifiers specified by the scheduler or otherwise inputted thereto, such as by a system operator or as a function of requests received from the media devices. For example, the scheduler may identify one or more video feeds to be included based on time-based triggers, such as a time of day. Of course, the present invention contemplates any number of logical processes and software applications for determining which video feeds to include within the user interface and is not intended to be limited to the use of a scheduler or other similar feature.

Additionally, the determination may include the automation processor communicating with the separator and/or directly with the media providers to determine which videos are available. In particular, the present invention contemplates an environment where media may be provided through any number of media publishing points and delivered therefrom to the separator for inclusion within the user interface. The availability of such media may be determined by the separator and communicated to the automation processor so that a video feed identifier may be assigned thereto and/or so that the video feed identifier may be extracted from the media content, i.e., in the case of the video feed having self-defining characteristics.

Block 454 relates to coordinating the transportation of the one or more video feeds associated with the video feed identifiers determined in block to the separator for further processing. This may require the automation processor to specify routing instructions to the separator for controlling which video feeds received by the separator are utilized for further processing. Likewise, however, the present invention contemplates other environments where the separator may only receive requested video feeds such that the automation processor may be required to communicate directly with the media providers in order for the video feeds associated therewith to be transported to the separator.

Block 458 relates to separating the received video feeds into video and audio feeds. The video and audio feeds may be extracted from the video feeds to facilitate independent processing. As described below in more detail, the video feeds may be scaled to smaller videos so as to fit within a composite video feed. The audio feeds comprise less bandwidth than the video feeds, and therefore, may not need to be scaled to facilitate downstream transmission. Of course, the present invention contemplates any number of operations, including simultaneously processing the video and audio feeds without the separation thereof.

Block 460 relates to combining the video feeds into a composite video feed. The feeds may be combined according to any number of operations and applications. The feeds may be combined by scaling each video feed for inclusion within a composite feed. This may include the separator receiving any number of instructions from the automation processor for arranging, compressing, and otherwise configuring each of the video feeds for inclusion within the composite video feed. The automation processor may receive instructions from the scheduler which specify the processing of the multiple video feeds and/or it may receive similar instructions from system operators or the users themselves.

Block 462 relates to adding a background overly to the composite video feed for covering blank portions within the composite video feed and/or for providing other aesthetics. This may include the overlay processor receiving any number of instructions from the automation processor for compiling, generating, or otherwise configuring the background videos and instructing the overlay processor where to insert such videos. The automation processor may receive the instructions from the scheduler and/or it may receive similar instructions from system operators or the users themselves.

Block 464 relates to determining secondary information for the video feeds included within the composite feed. The secondary information may be determined from a look-up table, storage database, or other storage medium and may be cross-referenced based on the video feed identifiers associated with the video feeds included within the composite video feed. The secondary information may also be extracted from metadata provided by the media providers or other vendors, such as EPG vendors.

The secondary information may include information related to the content of the video feeds, such as a synopsis or other summary of the program, lists of actors and actress, ratings, running times, and other information associated with the video feeds. Likewise, the secondary information may relate to advertisements and other information associated with the video feeds. The advertisements may further include instructions for display only and/or they may include instructions for specifying user selectable features which may be selected through the user interface for purchasing the product associated therewith.

Block 468 relates to determining user interface instructions for instructing the media device to display the user interface so that the video feeds and secondary information may be viewed by the user. The user interface instructions may leverage off of existing user interface capabilities existing on the media device such that the instructions may be correlated with those understood by the media device. In this manner, the present invention may specify navigation features, advertisement features, information (data) display features and the like for inclusion within user interfaces already supported by the media device. This allows the present invention to configure the user interface according to the secondary information associated with the video feeds and without having to transport large instructions sets to the media device.

Block 470 relates to associating the composite video feed, audio feeds, and user interface instructions for transportation to the media devices. This may include combining the signals related thereto into a common video rich navigation (VRN) feed for transportation to the media devices, such as within a predefined frequency band of a medium used by the network to transport signals. The media devices may preferably tune to the VRN feed to receive the composite video feed, audio feeds, and user interface instructions.

Block 472 relates to tracking system operations. In more detail, it may be advantageous to track the video feeds, secondary information, and other parameters, such as user interaction with the user interface. This may include recording the advertisements transported with the user interface for use in billing advertisers, recording user navigation within the user interface to determine which advertisements or other features are being accessed by the users, and any number of other items related thereto.

Block 476 relates to dynamically updating content associated with the user interfaces, i.e., the video feeds, navigation features, or secondary information. This may include substituting new video feeds and/or secondary information for that which was previously provided by the user interface, such as to display different video content and/or advertisements. In particular, the present invention contemplates an environment where video, navigation features, secondary information, advertisements, and the like are capable of being updated at least as quickly as in 30 second intervals to display other videos and advertisements.

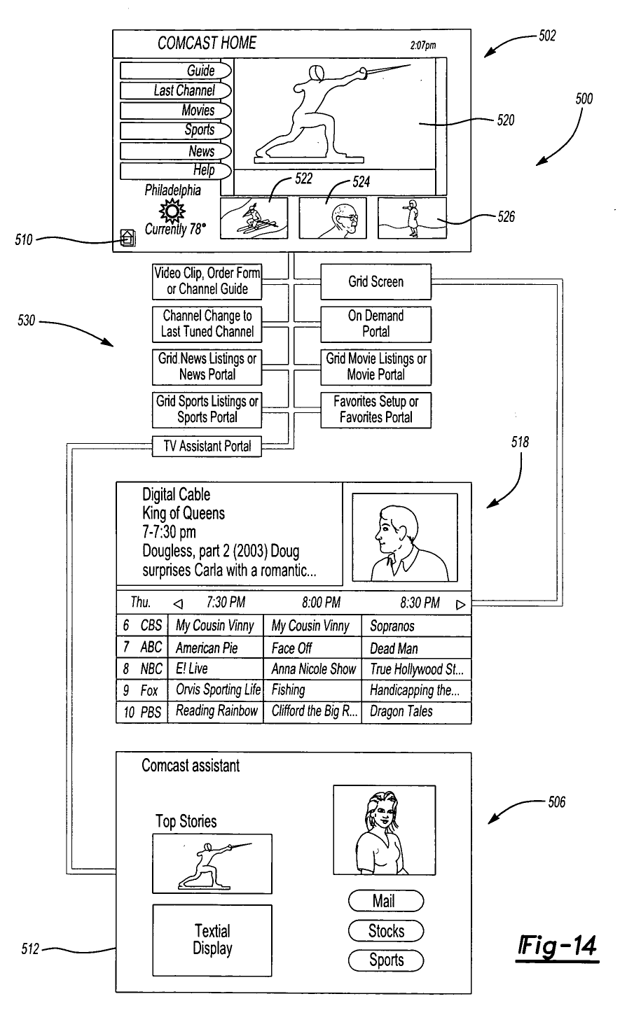

FIG. 14 illustrates a navigation tree 500 for a homepage user interface 502 in accordance with one non-limiting aspect of the present invention. The navigation tree 500 provides a number of navigation features which may be provided by the user interface to transport the user to different locations, interfaces, pages, portals, and other locations and/or to engage other capabilities and applications associated with the media device.

The user may navigate to a TV assistant portal user interface 506, such as by selecting a home icon 510 from the user interface 502. The TV assistant portal user interface 506 provides navigation features and other features related to user preferences, such as a display 512 related to stocks, news items, or other features of interest to the user. While not shown, the present invention contemplates features for the TV assistant portal 506 which permit the user to navigate to other information, locations, and features associated with their particular preferences, such as to TV channels, webpages, VOD guides, and the like.

The user may navigate to an electronic programming guide (EPG) user interface 518. The EPG user interface 518 may list a number of channels showing for a particular period of time. Information may be displayed for each channel to facilitate user selection thereof. The channel selection may tune the media device to a channel associated therewith. Each of the navigation features may be associated with user interfaces and other features to facilitate providing the associated navigation capabilities.

The home page user interface 502 may display video within a number of windows 520-526. The video may be associated with movies or programs available on demand or which may be tuned to for immediate viewing. Each of the windows 520-526 and other menus 528 may provide navigation capabilities such that the user may select them to display user interfaces related to a theme of the video or other options associated with the user interface. A number of such user interfaces having different themes and options are shown and generally referred to with reference numeral 530.

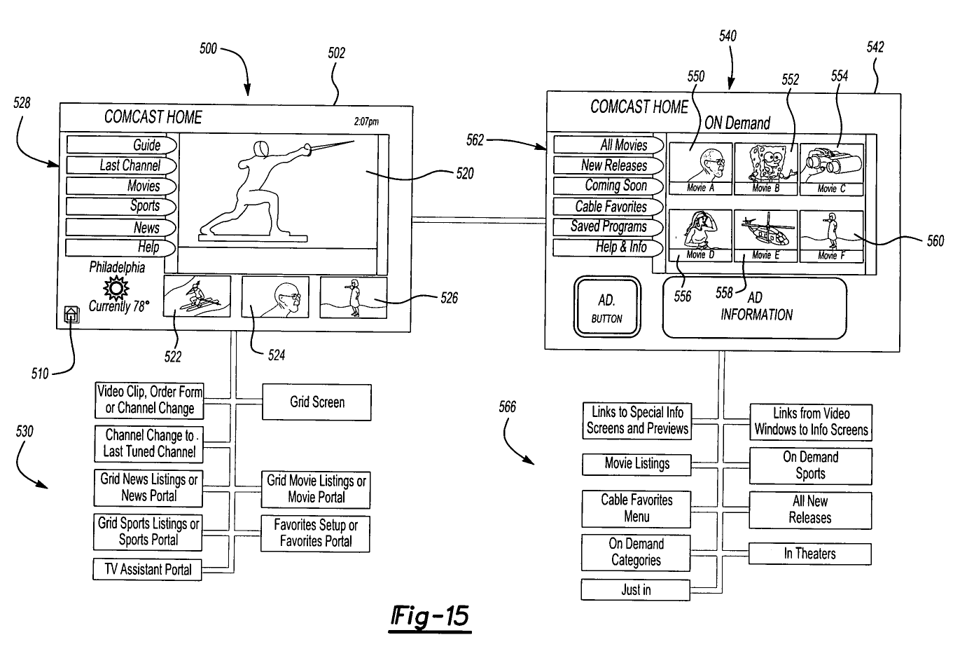

FIG. 15 illustrates a navigation tree 540 for a VOD user interface 542 in accordance with one non-limiting aspect of the present invention. The navigation tree 540 provides a number of navigation features which may be provided by the user interface to navigate the user to different locations, interfaces, pages, portals, and other locations and/or to engage other capabilities and applications associated with the media device.

The VOD user interface 542 may be called-up or otherwise display based on user interaction with the user interface shown in FIG. 14, such as by clicking on the on demand window 526, and/or through other means, such as by selecting a VOD button on a remote control. Each of the navigation features may be associated with user interfaces and other features to facilitate providing the associated navigation capabilities.

The VOD user interface 542 may display video within a number of windows 550-560. The video may be associated with movies or programs available on demand. Each of the windows 550-560 and other menus 562 may provide navigation capabilities such that they may be selected to display user interfaces related to a theme of the video or other options associated with the user interface. A number of such user interfaces having different themes and options are shown and generally referred to with reference numeral 566.

The VOD interface 540 may include icons or static images in place of video in one or more of the windows. The static images may save bandwidth or may be used to display posters and other features associated with new movies or programs.

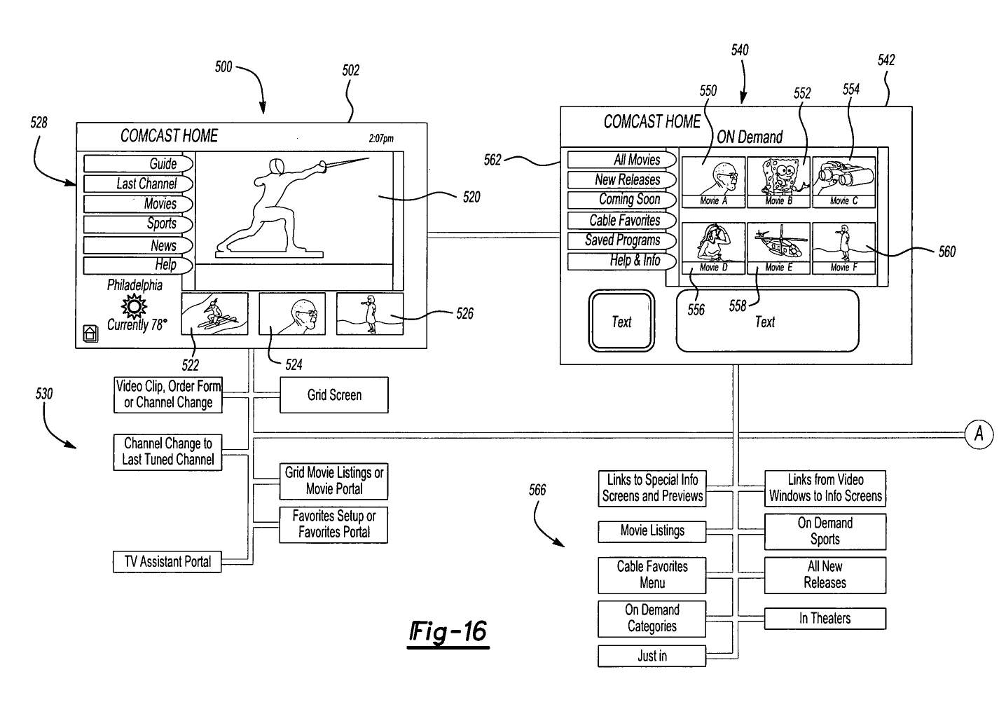

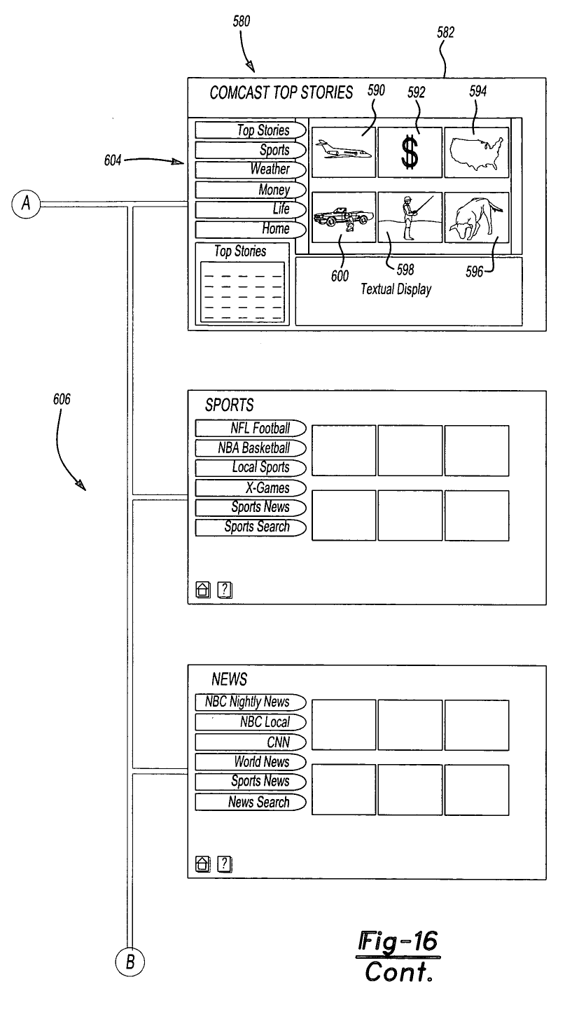

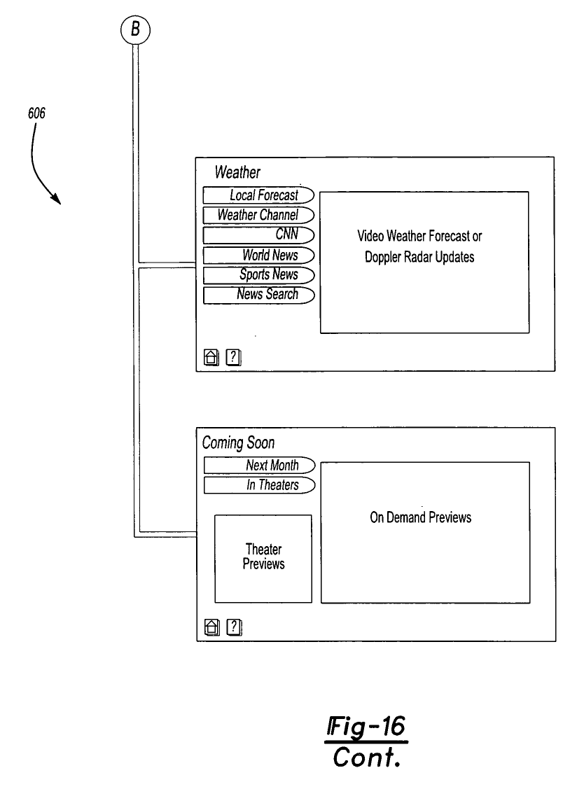

FIG. 16 illustrates a navigation tree 580 for a top stories user interface 582 in accordance with one non-limiting aspect of the present invention. The navigation tree 580 provides a number of navigation features which may be provided by the user interface to transport the user to different locations, interfaces, pages, portals, and other locations and/or to engage other capabilities and applications associated with the media device.

The top stories user interface 582 may be called-up or otherwise display based on user interaction with the user interface shown in FIG. 14, such as by clicking on the top stories window 522, and/or through other means, such as by selecting a VOD button on a remote control. Each of the navigation features may be associated with user interfaces and other features to facilitate providing the associated navigation capabilities.

The top stories user interface 582 may display video within a number of windows 590-600. The video may be associated with top stories of the day and periodically changed to reflect different or new stories. Each of the windows 590-600 and other menus 604 may provide navigation capabilities such that they may be selected to display user interfaces related to a theme of the video or other options associated with the user interface. A number of such user interfaces having different themes and options are shown and generally referred to with reference numeral 606.

As shown in FIG. 16, each of the navigation trees (500, 540, 580) may be interconnect from a common trunk or based, i.e., the user interface 502. This allows the present invention to navigate from one user interface to another and to provide opportunities to navigation to or engage other capabilities of the media device in a user-friendly manner, i.e., the user is not required to initiate separate applications or exited out of running (displayed) applications (user interfaces).

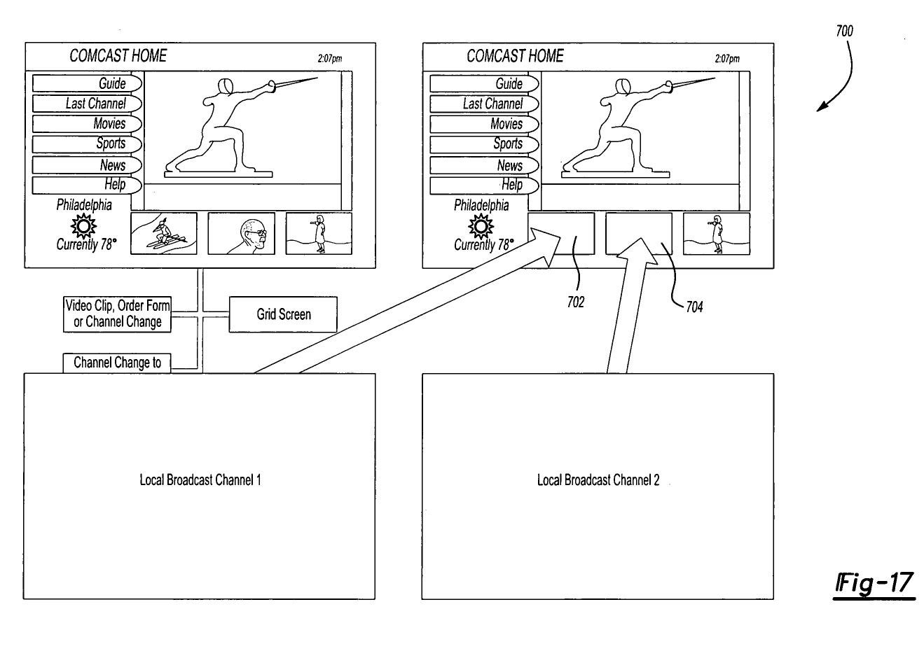

FIG. 17 graphically illustrates a user interface 700 being updated to include locally inserted content. The local content may be added to one or more windows 702-704 within the user interface 700 such that users downstream of the local insertion point view the locally inserted content. Navigation features and other features of the user interface, such as displayed text and graphics, may be coordinated with the locally inserted content to facilitate operations related thereto.

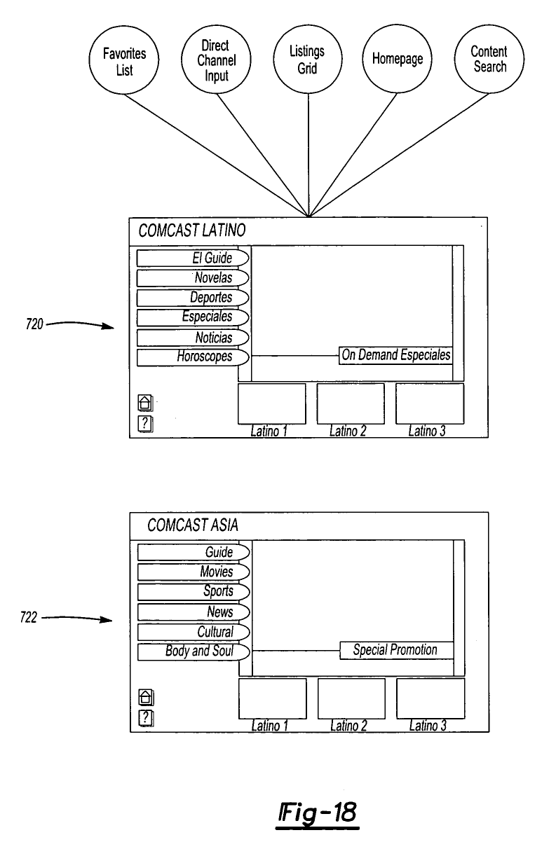

FIG. 18 illustrates a pair of user interfaces 720-722 configured to support non-English operations in accordance with one non-limiting aspect of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of directing operation of a media device having capabilities for displaying videos and a user interface, the method comprising:
providing at least two video feeds within a composite video feed, the media device being configured to display the composite video feed and thereby each video feed included therein; and
providing user interface instructions, the user interface instructions being operable with the media device to facilitate displaying the user interface, the user interface instructions including navigation instructions specific to content of at least one of the video feeds within the composite video so as to facilitate providing navigation features within the user interface that are specific to content of at least one of the video feeds.

2. The method of claim 1 further comprising configuring the navigation features to facilitate controlling the media device to display an electronic programming guide, the electronic programming guide displaying channels having content specific to at least one of the video feeds.

3. The method of claim 1 further comprising configuring the navigation features to facilitate controlling the media device to display a pop-up menu, the pop-up menu displaying media device control options for controlling the media device to execute operations specific to at least one of the video feeds.

4. The method of claim 3 further comprising configuring the media device control options to facilitate setting a recording of a content associated with the video feed, setting a reminder for tuning to a channel showing content associated with the video feed, tuning to a channel showing content associated with the video feed, adding information associated with the video feed to a favorites file, ordering a product associated with the video feed, or purchasing a movie associated with the video feed.

5. The method of claim 1 further comprising configuring the navigation features to facilitate controlling the media device to display an VOD guide, the VOD guide displaying content specific to at least one of the video feeds.

6. The method of claim 1 further comprising configuring the navigation features to facilitate controlling the media device to engage an application program interface (API).

7. The method of claim 1 further comprising configuring the navigation features to facilitate controlling the media device to display a webpage, the webpage having content specific to at least one of the video feeds.

8. The method of claim 1 further comprising configuring the navigation features to facilitate controlling the media device to tuned to a channel associated with one of the video feeds.

9. The method of claim 1 further comprising configuring the user interface instructions to include instructions for displaying an advertisement.

10. The method of claim 8 further comprising automatically updating the user interface instructions to facilitate displaying a different advertisement so as to facilitate barking operations wherein different advertisements are automatically displayed within the user interface at predefined periods.

11. The method of claim 8 further comprising configuring the user interface instructions to include navigation features for transporting to additional information on products or services associated with the advertisement.

12. The method of claim 8 further comprising configuring the advertisement to display content specific to at least one of the video feeds.

13. The method of claim 1 automatically updating the user interface instructions at predefined periods, wherein the user interface instructions are automatically provided from an electronic database so as to facilitate updating of the user interface instructions without manual interaction.

14. The method of claim 13 further comprising automatically changing content associated with at least one of the video feeds and automatically providing the user interface instructions to support the changed content.

15. The method of claim 13 further comprising automatically adding a video feed to the composite video feed and automatically providing the user interface instructions to support the changed content.

16. The method of claim 13 further comprising automatically subtracting a video feed from the composite video feed and automatically providing the user interface instructions to support the changed content.

17. The method of claim 1 further comprising transporting the composite video feed and user interface instructions within a common transport from a location upstream from the media device.

18. The method of claim 1 further comprising coordinating the user interface instructions to correspond with user interface capabilities of the media device.

19. The method of claim 1 further comprising associating a background overlay with the composite video feed to fill blank portions of the composite video feed.

20. The method of claim 1 further comprising providing user interface instructions for displaying information within the user interface, the displayed information being specific to content of at least one of the video feeds.

21. The method of claim 20 further comprising configuring the user interface instructions to change the displayed information according to user interaction with the user interface.

22. The method of claim 1 further comprising associating audio feeds with each of the video feeds and configuring the user interface instructions to facilitate selective playback of the audio feeds while the composite video feed and user interface are displayed.

23. The method of claim 1 further comprising scaling the video feeds prior fit within the composite video feed.

24. The method of claim 23 further comprising scaling the video feeds at a location upstream from the media device.

25. The method of claim 23 further comprising scaling the video feeds at the media device.

26. The method of claim 1 further comprising selecting the video feeds according to instructions provided by a scheduler associated with an automation processor.

27. The method of claim 1 further comprising coordinating delivery of the video feeds between one or media providers and a video processor, wherein the video processor combines the video feeds into the composite video feed.

28. The method of claim 1 further comprising removing one of the video feeds from the composite video feed and replacing it with a locally inserted video feed.

29. The method of claim 28 further comprising updating the user interface instructions with locally inserted user interface instructions to facilitate providing navigation features associated with the locally inserted video feed.

30. The method of claim 1 further comprising tracking features associated with the user interface for use in billing advertisers.

31. The method of claim 1 further comprising selecting the video feeds as a function of user requests.

32. The method of claim 1 further comprising arranging the video feeds within the composite video feed according to instructions provided by an automation processor.

33. The method of claim 1 further comprising arranging the video feeds within the composite video such that at least one of the video feeds appears larger than the other video feeds.

34. The method of claim 1 further comprising arranging the video feeds according one of a number of predefined mosaics.

35. The method of claim 1 further comprising adjusting the resolution of one or more of the video feeds to save bandwidth.

36. The method of claim 1 further comprising receiving at least one of the video feeds from a VOD server.

37. The method of claim 1 further comprising receiving at least one of the video feeds from a video broadcasting source.

38. The method of claim 1 further comprising receiving at least one of the video feeds from a satellite source.

39. The method of claim 1 further comprising receiving at least one of the video feeds from a packet-switching network.

40. The method of claim 1 further comprising transporting the composite video feed and user interface instructions in a linear transport.

41. The method of claim 40 further comprising configuring the user interface instructions to support navigation to a non-linear transport in response to selection of one or more of the features provided in the user interface.

42. The method of claim 1 further comprising outputting the composite video feed and the user interface from the media device.

43. The method of claim 1 further comprising assembling the composite video feed at a location upstream from the media device.

44. The method of claim 43 further comprising assembling the user interface instructions with the composite image feed at the location upstream from the media device.

45. The method of claim 1 further comprising providing the composite video feed and the user instructions to the media device in separate transport streams.

46. A method of providing a user interface, the method comprising:
providing a video feed and user interface instructions, the user interface instructions including features for instructing a media device to display features within a user interface during viewing of the video feed;
associating the displayed features with content specific to the video feed such that the user interface displays features specific to the video feed; and
automatically updating the user interface instructions at predefined periods, wherein the user interface instructions are automatically provided from an electronic database so as to facilitate updating of the user interface instructions without manual interaction.

47. The method of claim 46 further comprising configuring the user interface instructions to include instructions for displaying an advertisement.

48. The method of claim 47 further comprising automatically updating the user interface instructions to facilitate displaying a different advertisement so as to facilitate barking operations wherein different advertisements are automatically displayed within the user interface at predefined periods.

49. The method of claim 47 further comprising configuring the user interface instructions to include navigation features for transporting to additional information on products or services associated with the advertisement.

50. The method of claim 47 further comprising configuring the advertisement to display content specific to the video feed.

51. The method of claim 46 further comprising configuring the user interface instructions to provide navigation features specific to content of the video feed.

52. The method of claim 51 further comprising configuring the navigation features to facilitate controlling the media device to display an electronic programming guide, the electronic programming guide displaying channels having content specific to the video feed.

53. The method of claim 51 further comprising configuring the navigation features to facilitate controlling the media device to display a pop-up menu, the pop-up menu displaying media device control options for controlling the media device to execute operations specific to the video feed.

54. The method of claim 53 further comprising configuring the media device control options to facilitate setting a recording of a content associated with the video feed, setting a reminder for tuning to a channel showing content associated with the video feed, tuning to a channel showing content associated with the video feed, adding information associated with the video feed to a favorites file, ordering a product associated with the video feed, or purchasing a movie associated with the video feed.

55. The method of claim 51 further comprising configuring the navigation features to facilitate controlling the media device to display an VOD guide, the VOD guide displaying content specific to the video feed.

56. The method of claim 51 further comprising configuring the navigation features to facilitate controlling the media device to engage an application program interface (API).

57. The method of claim 51 further comprising configuring the navigation features to facilitate controlling the media device to display a webpage, the webpage having content specific to the video feed.

58. The method of claim 46 further comprising automatically changing content associated with the video feed at a predefined video feed update period, and updating the user interface instructions to display features specific to the changed content.

59. The method of claim 46 further comprising configuring the video feed to include at least two separate video portions, and associating the displayed features with at least one of the two video portions.

60. The method of claim 59 further comprising configuring the user interface instructions to include instructions to facilitate displaying at least two different configurations of the user interface, wherein at least one of the configurations covers at least one of the video portions shown within the video feed and wherein at least one of the configurations covers a different one of the video portions.

61. The method of claim 60 further comprising selectively controlling which one of the user interface configurations is displayed so as to control which one or more video portions within the video feed are shown.

62. A method of directing operation of a media device having capabilities for displaying videos and a user interface, the method comprising:
providing at least two video feeds within a composite video feed, the media device being configured to display the composite video feed and thereby each video feed included therein;
providing user interface instructions, the user interface instructions being operable with the media device to facilitate displaying the user interface, the user interface instructions including instructions to facilitate displaying at least two different configurations of the user interface, wherein at least one of the configurations covers at least one of the video feeds shown within the composite video feed and wherein at least one of the configurations covers a different one of the video feeds; and
selectively controlling which one of the user interface configurations is displayed so as to control which one or more video feeds within the composite video feed are shown.

63. The method of claim 62 further comprising configuring the user interface instructions to specify placement of selectable features within the user interface such that the placement of the selectable features controls which one or more video feeds with the composite video feed are shown.

64. The method of claim 62 further comprising configuring the user interface instruction to include navigation instructions specific to content of at least one of the video feeds within the composite video feed so as to facilitate displaying user selectable navigation options within the user interface that are specific to content of at least one of the video feeds

65. The method of claim 62 further comprising automatically changing content associated with at least one of the video feeds and automatically providing the user interface instructions to support the changed content.

66. The method of claim 62 further comprising automatically adding a video feed to the composite video feed and automatically providing the user interface instructions to support the changed content.

67. The method of claim 62 further comprising automatically subtracting a video feed from the composite video feed and automatically providing the user interface instructions to support the changed content.

68. The method of claim 62 further comprising receiving user requests with the media device and selectively controlling which one of the user interface configurations is shown as a function thereof.

69. The method of claim 62 further comprising receiving user requests at a location upstream from the media device and selectively controlling which one of the user interface configurations is shown as a function thereof.

70. A system of providing a user interface, the system comprising:
a media device configured to receive user interface instructions and to output a user interface as a function thereof, the media device further configured to receive a video feed; and
an automation processor configured to provide the user interface instructions, the user interface instructions including features specific to content of the video feed so as to facilitate displaying user interface features that are specific to content of the video feed.

71. The system of claim 70 wherein the automation processor is configured to automatically update the user interface instructions at predefined periods.

72. The system of claim 71 further comprising a scheduler in communication with the automation processor to facilitate automatically updating the user interface instructions, the scheduler specifying the predefined periods associated with updating the user interface instructions.

73. The system of claim 72 wherein the scheduler further specifies predefined periods for changing content associated with the video feed.

74. The system of claim 73 further comprising a database of secondary information in communication with the automation processor to facilitate updating the user interface instructions, the database including secondary information relating to content associated with the video feed, wherein the automation processor updates the user interface instructions as a function of the secondary information associated with the content of the video feed.

75. The system of claim 74 wherein the secondary information specifies at least a portion of the features to be displayed within the user interface.

76. The system of claim 70 further comprising an encoder configured to facilitate transporting the video feed and user interface instructions to the media device.

77. The system of claim 76 wherein the automation processor synchronizes the user interface instructions with the video feed to support transporting the video feed and user interface instructions to the media device in a common transport stream.

78. The system of claim 77 wherein the automation processor synchronizes the user instructions to compensate for processing latencies of the media device.

79. The system of claim 70 wherein the video feed is a composite video feed, the composite video feed being characterized as a single video feed having at least two individual feeds included therein, wherein the media device need only tune to the composite video feed to simultaneously display each video feed included therein.

80. The system of claim 79 further comprising a video processor for combining the individual video feeds into the composite video feed.

81. The system of claim 80 wherein the video processor is configured to scale the individual video feeds to fit within the composite video feed.

82. The system of claim 81 wherein the automation processor is configured to direct the video processor to control sizing of the individual video feeds within the composite video feed.

83. The system of claim 83 wherein the scheduler specifies sizing of the individual video feeds within the composite video feed so as to facilitate automatically changing video feed sizing.

84. The system of claim 79 wherein the automation processor is configured to direct the video processor to control placement of the individual video feeds within the composite video feed.

85. The system of claim 84 wherein the scheduler specifies placement of the individual video feeds within the composite video feed so as to facilitate automatically change video feed positioning.

86. The system of claim 80 wherein the automation processor coordinates delivery of the video feeds between at least one of a number of media providers and the video processor.

87. The system of claim 80 further comprising a separator located upstream form the video processor for separating audio out from the video feeds such that the video processor only processes video into the composite video feed.

88. The system of claim 87 further comprising an audio processor configured for processing the audio separated out of the video feeds to compensate for processing delays associated with video processing.

89. The system of claim 79 wherein the composite video feed includes blank portions between the individual video feeds, and wherein the system further includes an overlay process for adding an overlay to at least a portion of the blank portions of the composite video feed, the overlay becoming part of the composite video feed such that the media device need only tune to the composite video feed to display the each video feed and the overlay included therein.

90. The system of claim 89 wherein the automation processor is configured to select the overlay so as to facilitate automatically changing graphics, images, or other features associated therewith.

91. The system of claim 90 wherein the scheduler specifies selection of the overlay so as to facilitate automatically changing the overlay.

92. The system of claim 79 further comprising a local insertion unit configured to replace one of the video feeds from the composite video feed with a local video feed.

93. The system of claim 79 wherein the user interface instructions including instructions to facilitate displaying at least two different configurations of the user interface, wherein at least one of the configurations covers at least one of the video feeds shown within the composite video feed and wherein at least one of the configurations covers a different one of the video feeds.

94. The system of claim 93 wherein the user interface instructions include instructions to facilitate selectively controlling which one of the user interface configurations is displayed so as to control which one or more video feeds within the composite video feed are shown.

95. The system of claim 70 wherein the media device is a settop box configured to display the user interface and the video feed on a television.

96. The system of claim 70 wherein the media device is a server configured to stream the video feed and the user interface to a unit for playback.

97. The system of claim 95 further comprising user instructions for displaying pop-up navigation features during playback of the video feed.

98. A system of providing a video rich user interface, the system comprising:
an number of media providers, the media providers configured to provide one or more video feeds;
a video processor in communication with the media provider to receive the video feeds, the video processor further configured to combine the video feeds into a composite video feed;
an automation processor configured for selecting the video feeds included within the composite video feed, the automation processor further configured to provide user interface instructions, the user interface instructions being specific to content of the selected video feeds, the user interface instructions providing instructions operable with a media device to display a user interface so as to facilitate displaying features in the user interface that are specific to content of one or more of the selected video feeds; and
a scheduler in communication with the automation processor for instructing the automation processor to automatically update, add, or subtract one of the select video feeds and/or to automatically update the user interface instructions as a function thereof or independently thereof.

99. The system of claim 96 further comprising a database of secondary information in communication with the automation processor to facilitate updating the user interface instructions, the database including secondary information relating to content associated with the video feeds, wherein the automation processor updates the user interface instructions as a function of the secondary information associated with the content of the video feed.

100. The system of claim 97 wherein the secondary information specifies one or more navigation features to be provided within the user interface, the navigation features being specific to content of the selected video feeds.

101. The system of claim 97 wherein the secondary information specifies one or more advertisements to be displayed within the user interface, the advertisements being specific to content of the selected video feeds.

102. The system of claim 97 wherein the secondary information specifies one or more textual or graphical displays to be displayed within the user interface, the textual or graphical displays being specific to content of the selected video feeds.

103. A system of providing a user interface, the system comprising:
a composite video feed for displaying a number of individual video feeds;
a number of user interface instructions configured to facilitate displaying at least two different configurations of a user interface, wherein at least one of the configurations covers at least one of the video feeds shown within the composite video feed and wherein at least one of the configurations covers a different one of the video feeds; and
a media device configured to display the composite video feed and the user interface.

104. The system of claim 103 further comprising an automation processor configured to select an arrangement of the video feeds within the composite video feed and to determine the different configurations of the user interface as a function thereof.

105. The system of claim 104 wherein the user interface instructions specify placement of selectable features within the user interface such that the placement of the selectable features controls which one or more video feeds with the composite video feed are shown.

106. The system of claim 104 wherein the user interface instructions define the different user interface configurations according to different themes, and wherein the video feeds within the composite video feed are correlated with the different themes so as to permit selection of the user interfaces by theme and the display of the videos associated with the selected theme.

107. A system of providing a user interface, the system comprising:
a media device having capabilities for displaying videos and a user interface;
a regional enterprise configured for:
providing at least two video feeds within a composite video feed, the media device being configured to display the composite video feed and thereby each video feed included therein; and
providing user interface instructions, the user interface instructions being operable with the media device to facilitate displaying the user interface, the user interface instructions including navigation instructions specific to content of at least one of the video feeds within the composite video so as to facilitate providing navigation features within the user interface that are specific to content of at least one of the video feeds; and
a local enterprise located downstream from the regional enterprise and upstream from the media device, the location enterprise configured to remove at least one video feed from the composite video feed and to update the user interface instructions as a function thereof such that the updated user interface instructions and composite video feed with the at least one local video feed are transported downstream to the media device.

108. The system of claim 107 wherein the local enterprise includes a local server in communication with the regional enterprise, the local server being configured to synchronize local video insertion and user interface instructions updating with a VRN channel transmitted from the regional enterprise, the VRN channel including the composite video feed and user instructions provided by the regional enterprise.

109. The system of claim 108 further comprising a communication medium for communication time codes between the regional enterprise and the local server to facilitate synchronization.
